(19) United States
(12) Patent Application Publication
(10) Pub. No.: US 2026/0149996 A1
(43) Pub. Date: May 28, 2026

(54) DETERMINING IDENTITY OF NEIGHBOR CELLS BASED ON LIMITED INFORMATION

(71) Applicant: NTT DOCOMO, INC., Tokyo (JP)

(72) Inventors: Haralabos Papadopoulos, Sunnyvale, CA (US); Fujio Watanabe, Sunnyvale, CA (US); Yoshiaki Oofuji, Tokyo (JP)

(21) Appl. No.: 19/399,361

(22) Filed: Nov. 24, 2025

Related U.S. Application Data
(60) Provisional application No. 63/725,866, filed on Nov. 27, 2024.
(60) Provisional application No. 63/725,857, filed on Nov. 27, 2024.
(60) Provisional application No. 63/725,851, filed on Nov. 27, 2024.

(51) Int. Cl. H04W 24/10; H04W 36/32

(52) U.S. Cl. CPC H04W 24/10; H04W 36/32

(57) ABSTRACT

Methods and apparatuses for determining identity of neighbor cells are disclosed. In some embodiments, a method for neighbor-cell disambiguation includes: receiving user equipment (UE) measurement reports; and determining which combination of neighbor cells would have produced the set of physical cell IDs (PCIs) in the UE MR by determining cells in each combination that have a common region of geometric radio-coverage overlap with a serving cell of the UE.

### RELATED APPLICATIONS

The present application claims the benefit of U.S. Provisional Patent Application No. 63/725,866, filed on Nov. 27, 2024 and entitled “CONSTRUCTION OF TRIPARTITE GRAPHS AND ALGORITHMS FOR OFFLOADING UES AND PUTTING SERVING CELLS IN SLEEP MODE”, U.S. Provisional Patent Application No. 63/725,857, filed on Nov. 27, 2024 and entitled “DETERMINING IDENTITY OF NEIGHBOR CELLS BASED ON LIMITED INFORMATION”, and U.S. Provisional Patent Application No. 63/725,851, filed on Nov. 27, 2024 and entitled “DETECTING RADIO COVERAGE OVERLAP OF TWO OR MORE CELLS”, all of which are incorporated herein by reference in their entirety.

### FIELD OF THE INVENTION

Embodiments of the present disclosure are related to wireless communication; more particularly, embodiments disclosed herein are related to cellular communication where cells are identified for entry into a reduced power consumption state and the user equipments (UEs) they are servicing are move to other cells.

### BACKGROUND

Today, mobile network operators consider power consumption and carbon dioxide consumption because the energy used to power mobile networks contributes to greenhouse gas emissions and climate change. In addition to the environmental impact, excessive power consumption can also result in increased operational costs for network operators. Therefore, by considering and reducing their power consumption and carbon dioxide emissions, mobile network operators can help mitigate the negative impact of their operations on the environment, while also improving their bottom line.

One of the options people are considering for reducing power usage is turning base-stations off during low traffic periods. However, if a mobile network operator puts a cell to sleep, they can create a coverage hole, which would make many of their customers unhappy. One solution to handle the coverage hole is to have nearby cells tilt their antennas up in order to increase their coverage in an attempt to close the coverage hole. There are a number of issues that exist with this approach. First, even after titling, the coverage hole may still exist. Second, titling the antennas of nearby cells can cause more interference in other nearby cells (which are not put to sleep). Furthermore, handovers between the cells can also be affected such that there may be an increased number of failed handovers due to re-tilting. All of these problems can become even more aspirated if a mobile network operator wants to put several cells to sleep at the same time to save significant power.

### SUMMARY

Methods and apparatuses for constructing tripartite graphs are disclosed. In some embodiments, a method includes: receiving wirelessly transmitted measurement reports from user equipments (UEs); creating, in response to the measurement reports, a tripartite graph that includes first, second and third sets of nodes, the first set of nodes representing a plurality of cells, the third set of nodes representing a plurality of UEs receiving coverage from the plurality of cells, each node in the second set of nodes representing a group of one or more cells of the plurality of cells and being connected in the tripartite graph between the one or more cells in the group and one or more UEs to which cell coverage can be obtained from at least one cell in the group provided the one or more cells in the group are indicted as on in the tripartite graph; and determining, based on the tripartite graph, cell coverage for a plurality of UEs with a set of active cells from the plurality of cells.

Other aspects and advantages of the embodiments will become apparent from the following detailed description taken in conjunction with the accompanying drawings which illustrate, by way of example, the principles of the embodiments described.

### BRIEF DESCRIPTION OF DRAWINGS

The embodiments described and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a flow diagram of some embodiments of a process for constructing and using a tripartite graph.

FIG. 1B is a flow diagram of some other embodiments of a process for constructing a and using a tripartite graph.

FIGS. 2A and 2B illustrate an example of a coverage problem.

FIG. 3 is a flow diagram of some embodiments of a process for creating a tripartite graph and using it for determining which cells to place into a reduced power consumption state (e.g., a sleep state).

FIGS. 4A-4G illustrate an example of tripartite graph and example reductions based on PCIs from measurement reports (MRs).

FIG. 5 illustrates an example of a tripartite graph.

FIGS. 6A-6J illustrate an example of a coverage algorithm that is applied on a tripartite graph.

FIG. 7A illustrates an example of a tripartite graph.

FIG. 7B illustrates an example of an extended tripartite graph.

FIGS. 7C and 7D illustrate an original tripartite graph and an extended tripartite graph, respectively.

FIG. 8A-8G illustrates an example of processing of a tripartite graph.

FIGS. 9A and 9B illustrate different embodiments in which the set of likely neighbor ECIs are determined based on a sector list.

FIG. 10 illustrates an example coverage overlap.

FIGS. 11A-11C illustrate omni-coverage modeling using convex polygons.

FIGS. 12A and 12B illustrates an example of the use of linear constraints representing a circular sector.

FIGS. 13A and 13B illustrates an example of a non-convex region being represented as two convex regions.

FIG. 14 illustrates example of representing sector coverage.

FIG. 15 illustrates a network an example network in which a service cell is overlapped in coverage by two cells that have the same PCI.

FIGS. 16A-16B illustrate a first example of a per-cell embodiment.

FIGS. 17A-17C illustrate a second example of a per-cell embodiment in which neighbor cells are identified based on a band restriction.

FIGS. 18A-18B illustrate an example of a per-UE embodiment.

FIGS. 19A-19C illustrate another example of a per-UE embodiment in which neighbor cells are identified based on a band restriction.

FIGS. 20A-20C illustrate another example of a per-UE embodiment in which neighbor cells are identified.

FIGS. 21A-21C illustrate yet another example of a per-UE embodiment in which neighbor cells are identified based on a band restriction.

FIGS. 22A-22C illustrate another example of a per-UE embodiment in which neighbor cells are identified based on a band restriction.

FIG. 23 is a data flow diagram of some embodiments of a data preprocessing operation.

FIG. 24 illustrates some embodiments of generating raw graph dictionaries for use in creating tripartite graphs and using that information to support powering down serving cells and offloading UEs of those power down serving cells.

FIG. 25 is a data flow diagram of some embodiments of a process for creating a tripartite graph.

FIG. 26 illustrates some embodiments of a set of algorithm objects utilized to create the tripartite graph.

FIG. 27 is a data flow diagram of some embodiments of a process for determining which cells to turn off while offloading any of the UEs being served by those cells.

FIGS. 28A-28B and 29 illustrate examples of using metrics as described above to determine which cells are to be put on and which can be placed into reduced power consumption state, while still maintaining coverage for the UEs

FIG. 30 is a block diagram of some embodiments of a base station.

FIG. 31 is a data flow diagram of some embodiments of a process for determining cell coverage for UEs.

FIG. 32 is a data flow diagram of some embodiments of a process for performing neighbor-cell disambiguation.

FIG. 33 is a data flow diagram of some other embodiments of a process for determining cell coverage for UEs.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Note for purposes herein, a cell in a mobile network represents a specific geographical area covered by a base station. Each cell is covered by a base station and the coverage area of each cell can vary and undergo changes over time. There may be a number of reasons for these changes such as, for example, the base station antenna parameters, such as modifications to transmit power, electronic antenna tilt, and azimuth transmission direction or the cell environment changes (e.g., new buildings). For a user equipment (UE), cells are divided into serving cells and neighbor cells. The serving cell is the cell currently providing services to the UE, and where the UE is currently communicating (e.g., calls and data transmissions) with and through the base station of this cell. Neighbor cells are cells whose coverage overlaps the coverage of the serving cell and can become new serving cells. This change can occur when the UE moves to a new location. This change can also occur for purposes of load-balancing. For example, assume the serving cell becomes too congested with traffic and a nearby cell has very little traffic. In such a case, the Random Access Network (RAN) controller knows this situation, and it can signal the UEs in the congested cell to provide measurement reports in the band where the lightly-loaded cell operates (or, in some cases, on several bands with potentially lightly loaded cells). The UEs report back, and based on these reports, one or more of the UEs with a strong enough signal to the lightly loaded cell are transferred to that cell. Note that these UEs may have a lower Signal-to-Interference-plus-Noise Ratio (SINR) to the new cell, but because that cell is lightly loaded, they can be given a much larger portion of the resources (e.g., bandwidth) for communication. In addition, the UEs that remain in the loaded cells also get more resources, since the heavily loaded cell has offloaded some of its load.

Today there are a number of green initiatives to reduce power consumption. More recently, some of the focus of these initiatives has been on mobile networks. With this in mind, the mobile networks are evaluated at different time periods (e.g., the next time period) to determine whether it is possible to reduce, or potentially minimize, active network resources in order to reduce or minimize power usage subject to satisfying the traffic demand across a random access network (RAN). To that end, in some embodiments, the saving of power occurs by putting cells into sleep mode (e.g., turning off cells, cells being put in a reduced power consumption state) and offloading any UEs that were being served by those sleeping cells to other nearby active neighbor cells, thereby reducing power. In some embodiments, at different times in the day, network operators will be able to put certain cells in the network to sleep while still guaranteeing a high quality of experience (QoE) for UEs in the network.

Techniques disclosed herein are directed at a “generalized set coverage” problem that would have to be solved to determine which cells can be put into sleep mode, so that all their UEs can be offloaded to nearby active cells (and thus none of the UEs would end up in outage due to the applied energy saving mode). That is, the problem of reducing power via turning off cells and offloading the UEs served by those cells to other nearby active cells involves solving a coverage problem. In some embodiments, the coverage problem involves finding a number of cells in the network (e.g., a minimum number of cells) that can provide full coverage for the UEs within the network. Techniques disclosed herein leverage measurement reports from UEs in each serving cell to determine the neighbor cells to which each reporting UE could be offloaded. In some embodiments, a solution to the coverage problem can be applied to a RAN during periods of low traffic.

As for full coverage, a determination can be made based on measurement reports (MRs) that are sent by UEs to their serving cells to declare the neighbor cells. If each UE specified in its measurement report the exact identity of its cell neighbors, the problem could be converted to a “set covering” problem: the goal would be to select the minimum number of cells that cover all the UEs. These standard set-covering problems are well-known and arise in a broad range of applications. They can be represented by bipartite graphs. Heuristic algorithms for solving these problems on bipartite graphs exist.

However, while the MRs include information that helps identify the neighbor cells (e.g., be PCIs, band information, received RSRP, etc.), UE measurement reports only report Physical Cell IDs (PCIs) and not the exact identity of each cell. PCIs are assigned by the RAN operator and are supposed to be “locally unique” on each frequency band. The presence of only partial information about the identity of the neighbor cells renders standard “set covering” methods inadequate.

While identifying cells that can provide full coverage, in some embodiments, given the most recent MRs, the network finds the minimum number of cells that can provide full coverage and still satisfy the current traffic demands. The techniques disclosed herein include methods of mapping problems with partial neighbor-cell information to tripartite graphs, and algorithms propagating on these graphs that can ensure coverage.

In some embodiments, the determination of what constitutes full coverage can also be based on sector list data that provides information about deployed access points. In some embodiments, the sector list data includes longitude and latitude information, frequency band information, and antenna parameters (e.g., height, tilt, orientation, beam width, etc.) of access points. In some embodiments, the sector list data also includes RAN parameters (e.g., PCI, cell ID (ECI), sector reference, etc.). In some embodiments, one goal is to provide coverage to all the UEs in the MRs. For each UE in the MRs, at least one neighbor cell or the serving cell itself should stay active. By collecting MRs over a sufficient long period of time (e.g., a week), the network can guarantee within a high probability that all the UEs in the network can be covered by covering the MRs. Indeed, 3GPP provides provisions for periodic UE reporting across the bands used by the NW operator for providing network access to their UEs. These MRs effectively provide a uniform sampling of the offloading options available to UEs over the coverage space. Provided MRs are collected for long enough and over all typical types of traffic (e.g., morning, evening, weekdays, weekends), finding a cover-set of cells for all the MRs guarantees with very high probability that UEs will have coverage with the limited set of cover cells active.

Tripartite Graphs to Enable Offloading UEs to Nearby Cells and Putting Serving Cells into a Reduced Power Consumption State

As discussed above, the coverage problem can be handled by obtaining information from MRs of the UEs and using that information to create a tripartite graph. In some embodiments, the tripartite graph includes multiple nodes that represent cells, cell groups, and UEs. Once a tripartite graph has been constructed, a coverage algorithm is run on the tripartite graph to determine which cells can be put into a reduced power consumption state (e.g., a sleep state) and which cells can be active in order to provide coverage for UEs in the mobile network.

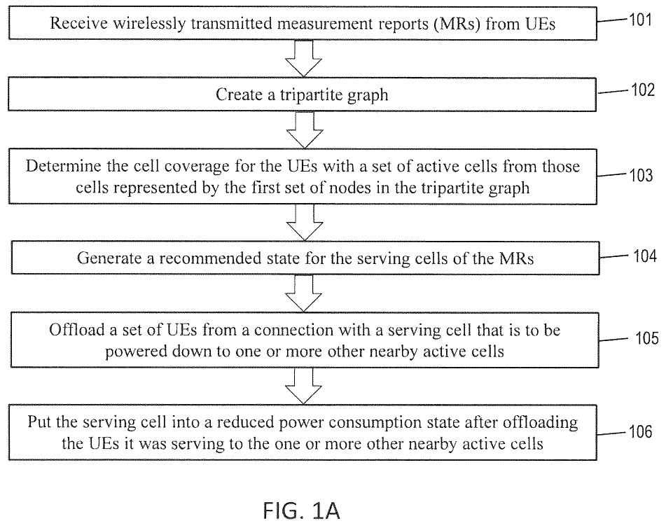

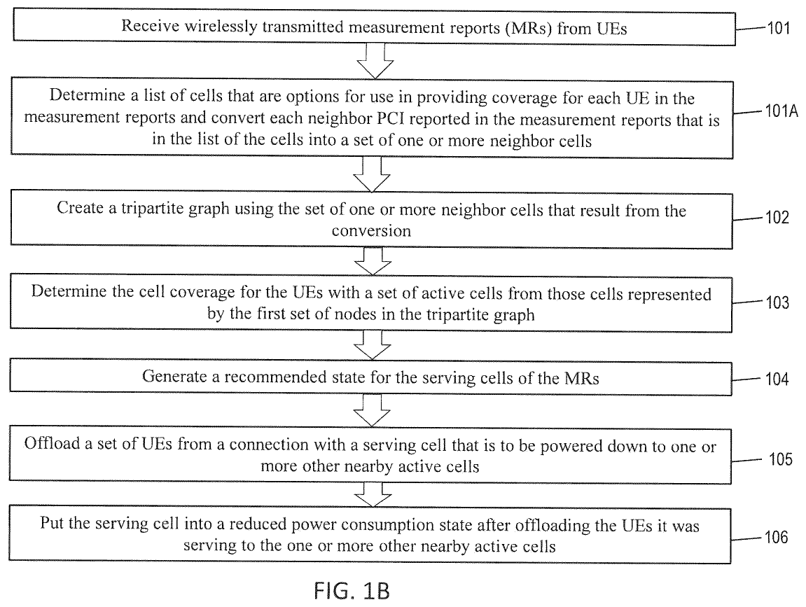

FIG. 1A is a flow diagram of some embodiments of a process for constructing and using a tripartite graph. The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 1A, the process begins by processing logic receiving wirelessly transmitted measurement reports (MRs) from UEs (processing block 101). In some embodiments, each measurement report is used to identify what may be referred to herein as “UE instances.” Each UE instance corresponds to the offloading options for a UE at a given place in the network. In some embodiments, such a UE instance is described as a subset of rows from a measurement report that were communicated by a single UE within a sufficiently small period of time (e.g., within 1-3 seconds). Such a UE instance lists the serving cell, neighbor PCIs (and possibly E-UTRA Absolute Radio Frequency Channel Numbers (EARFCNs)), as well the Reference Signal Received Power measurements (RSRPs) and Reference Signal Received Quality measurements (RSRQs) to the serving cell and neighbor PCIs.

In response to the MRs, processing logic creates a tripartite graph (processing block 102). In some embodiments, the tripartite graph includes first, second, and third sets of nodes. The first set of nodes represents cells in the network. A third set of nodes represents the UEs receiving radio-coverage from those cells represented by the first nodes. Each node in the second set of nodes represents a group of one or more cells of the cells represented by the first set of nodes and are connected between one or more cells in the group and the UEs to which the cells can provide radio-coverage.

After creating the tripartite graph, processing logic determines the cell coverage for the UEs with a set of active cells from those cells represented by the first set of nodes in the tripartite graph (processing 103). That is, processing logic determines a set of cells that can cover (provide radio-coverage to) the UEs in the tripartite graph.

In some embodiments, the process also includes generating a recommended state for the serving cells of the MRs (processing block 104). In some embodiments, the recommended state can comprise an active state or a sleep state for each of the cells that are serving UEs in the network. The active state indicates a cell that is to remain active when the network tries to reduce power consumption by powering down other cells in the network, while the sleep state indicates a cell that is to be put to sleep or into a reduced power consumption state when the network tries to reduce power consumption.

In some embodiments, upon determining cell coverage for the UEs (from the tripartite graph from the set of active cells from the cells represented by the first set of nodes in the tripartite graph), the process also includes offloading a set of UEs from a connection with a serving cell that is to be powered down to one or more other nearby active cells (processing block 105). In some embodiments, the nearby active cells are cells that are determined to overlap in radio coverage with the serving cell or cells of the UEs that are being offloaded.

The process can also include processing logic putting the serving cell into a reduced power consumption state after offloading the UEs it was serving to the one or more other nearby active cells (processing block 106). In some embodiments, before powering off a given cell X, the cell has the ability to ask each of its UEs to provide an “event-A4” type measurement report. This is a sequence of measurements per UE on each of the frequency bands specified by cell X. In each measurement, in some embodiments, a UE specifies the band being measured, the neighbor PCIs the UE sees, and their strength/interference level (e.g., RSRP, RSRQ measurements). In some embodiments, each such measurement also specifies the serving cell RSRP and RSRQ levels. Based on this information and given that the coverage algorithm has specified a covering set of cells to stay ON, at least one of these cells is reported by each UE. The cell X then proceeds to transfer the UE to one of these cells in the coverage set. The same procedure is currently followed for offloading UEs from a busy cell X, e.g., when cell X is congested and some of its neighbor cells have lighter coverage. Cell X collects event-A4 reports and offloads some of its UEs to nearby (lighter-loaded) cells where these UEs have sufficiently strong RSRP/RSRQ values.

In some embodiments, determining cell coverage to the UEs with a set of active cells based on the tripartite graph includes executing a coverage algorithm on the tripartite graph. In some embodiments, the coverage algorithm comprises a sleep-selection algorithm to determine which cells to place in a reduced power consumption state. In some embodiments, the coverage algorithm includes an incremental algorithm in which candidate cell-group nodes that are in the off state are changed to the on state one at a time (to create a new state to the tripartite graph), computing one or more metrics for the candidate cell-group node when in the on state to determine its impact of turning on that cell-group associated with the candidate cell-group node, comparing the one or more metrics for all candidate nodes, and turning one or more candidate cell-group nodes on based on a comparison of metrics. The algorithm can also include performing another iteration of these operations on the tripartite graph with the candidate node having the superior metric in the on state. These operations can be summarized as follows:

At iteration n:
1 Given: State of the tripartite graph (determined from the set of ON/OFF cells)
2 For each cell-group node p that is in the OFF state:
   i. Turn candidate node p ON
   ii. Obtain new (candidate) state for the tripartite graph
   iii. Compute a metric for candidate node p by comparing the new state with old
3 Turn ON the candidate node p with the highest metric
4 Update the state of the tripartite graph
5 Go to iteration n+1

In some embodiments, the metric comprises criteria indicative of whether additional UE nodes are covered when the cell group associated with the candidate node is on. In some other embodiments, the metric comprises criteria indicative of whether additional UE nodes are covered divided by extra cells that are on when the cell group associated with the candidate node is on. In some embodiments, turning one or more candidate nodes on based on a comparison of metrics includes turning one candidate node to the on state that has a superior metric in comparison to the metrics of the candidate nodes. Thus, in some embodiments, the metrics can be one of the following:

$$Criterion 1 := Extra UE nodes covered$$

$$Criterion 2 := \frac{Extra UE nodes covered}{Extra ECIs ON}$$

Note that other metrics can be used. In some other embodiments, the number of extra ECIs on is replaced by a sum of costs over the extra ECIs, where the cost per ECI is indicative of the power consumption associated with turning on that ECI. In some embodiments, this cost depends on the frequency band and its bandwidth and the equipment. The cost can also be state dependent. For example, it may be that the ECI is carrier within a coverage sector carrier. Carriers within a sector are based on collocated APs that serve the same coverage area over different frequency bands. In such cases the cost of an Extra ECI can depend on the state of other carriers in the sector. The cost for instance would be made higher if the all the other ECIs were in sleep mode, as more hardware parts may have to be awakened in that case resulting in an additional increase in energy expenditure.

While the algorithm above includes turning ON the candidate node p with the highest metric, in some other embodiments, there are variations where multiple nodes with sufficiently high metrics are turned on. For instance, in various embodiments, the following are all valid options:
A) the N nodes with the highest metric are turned on for some N value specified by a network (NW) engineer;
B) all the nodes with a metric within a predefined percentage of the highest metric node are turned on, with the number of nodes turned on in this case potentially varying from iteration to iteration,
C) initially step B is run to identify the M nodes within the predefined percentage of the highest metric, and if M>N, then the best N nodes are kept; else all M nodes are kept, and
D) a NW engineer specifies that the survivors are at most a % of the remaining (still inactive) cells. After running option C, the cell with the highest metric is kept and as many of the additional selected cells (from running C) as can be kept without having a set that is turned on that exceeds a % of the remaining cells.

After applying the coverage algorithm to the tripartite graph, the deployment of cells to an on state or off state is based on the state of the nodes in the tripartite graph. A cell node is covered if the corresponding cell is in the on state. A cell-group node is in the on state if all its cell neighbors are covered, and any such set of likely group is in the on state and can serve UEs. A UE node is covered if at least one of its cell group neighbors is in the on state. In other words, the computations on the tripartite graph are tailored for solving the coverage problem at hand which involves uncertainty in terms of which neighbor cells have broadcasted the PCI values reported by each UE, and cell group nodes are the middle nodes in the tripartite graph, with each such node being connected to one or more cells (the left nodes). A cell group (middle node) is active if and only if all the cells connected to it by an edge are also active, which signifies that UEs reporting the PCI value associated with a given cell group can only be “covered” with that PCI if all the likely nearby cells associated with that PCI value are turned on. These likely cells are all the cells that broadcast this PCI value and could have potentially led to that PCI measurement by the UEs reporting that PCI value in a given serving cell.

While the incremental algorithm can be used, other greedy or non-greedy algorithms can be applied to the tripartite graph as well. These may include faster algorithms. Other optimizations can be used such as the use of smaller graphs and/or parallelizing the process and/or running the process on graphic processing units (GPUs).

In some embodiments, a faster algorithm that is used is a multi-candidate selection algorithm. In such an algorithm, turning one or more candidate nodes to the on state based on a comparison of metrics includes turning a set of cell group candidates to the on state where the set of cell groups includes a cell group with a superior metric (e.g., largest impact, etc.) in comparison to the metrics of the other cell nodes and one or more additional criteria. These additional criteria can include those cell groups having metrics within a predetermined mathematical relationship with the superior metric, a predetermined percentage of cells in the cell group, and a predetermined number of cells in the cell group. These operations can be summarized as follows:

At iteration n:
Given: State of the tripartite graph (determined from the set of ON/OFF cells)
For each cell-group node p among the OFF cell-group nodes:
   Turn candidate node p ON
   Obtain new (candidate) state for the tripartite graph
   Compute a “metric” for candidate node p by comparing the new state with the old state
Turn ON a subset of the candidate nodes based on their metrics and potentially additional criteria (as described above for example)
Update the state of the tripartite graph
Go to iteration n+1
   The process terminates once all the UEs (right nodes) have been covered. The resulting set of covered cells (left nodes that are ON) correspond to the set of coverage cells, that is a set of cells that will guarantee coverage to all UEs if they are left always turned on.

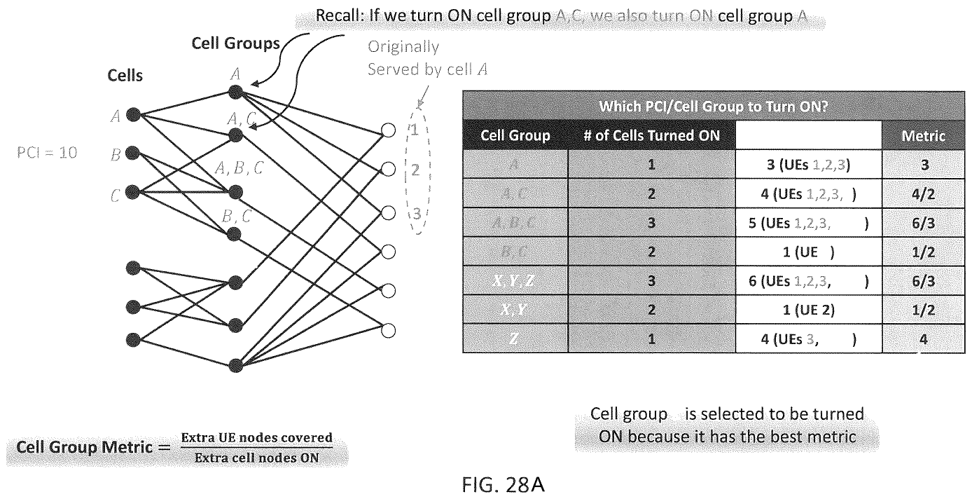

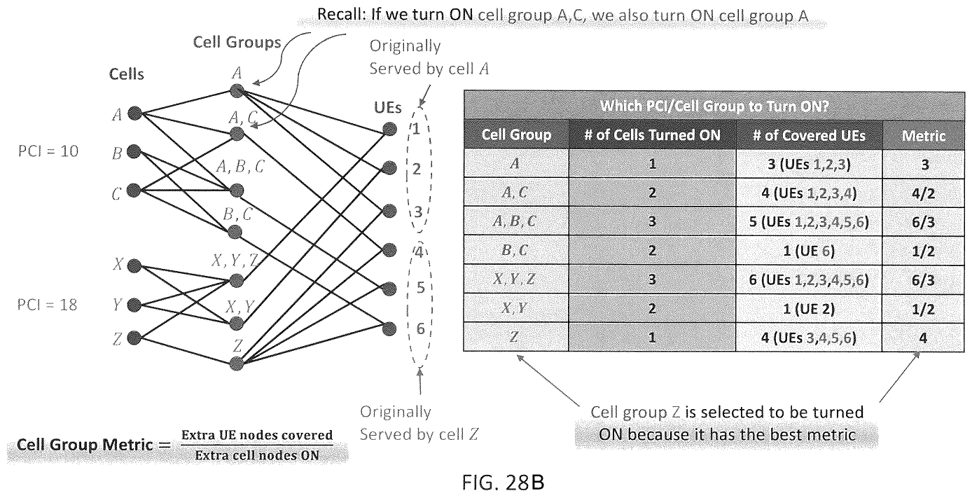

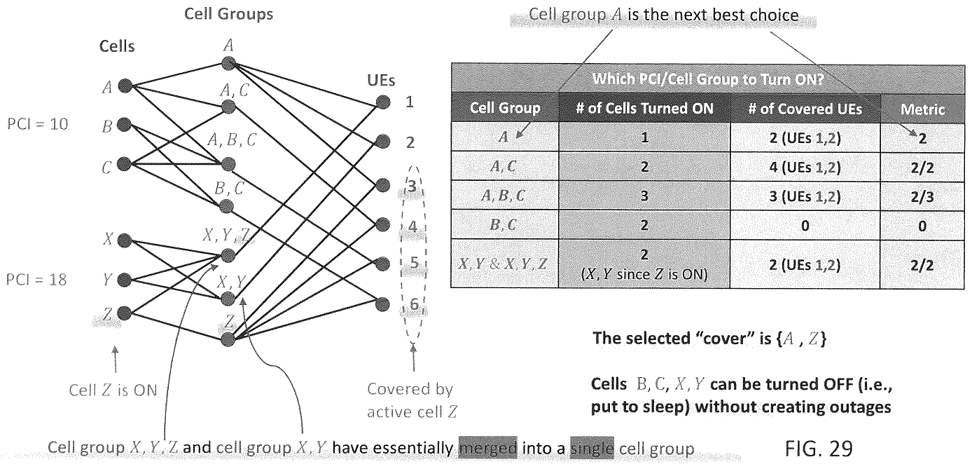

FIGS. 28A-28B and 29 illustrate examples of using metrics as described above to determine which cells are to be put on and which can be placed into reduced power consumption state, while still maintaining coverage for the UEs. In the example depicted in FIGS. 28A-28B and 29, the algorithm starts by initializing the set of coverage cells as the empty set. Turning on the middle node A in FIGS. 28A-28B requires turning on 1 cell on the left (cell A) and covers three UEs on the right (UEs 1, 2, and 3). The metric for turning on middle node A thus equals (3 covered UEs)/(1 cell) equals 3. Turning instead on middle node A,C requires turning on two cells on the left (cells A and C) and covers four UEs on the right (UEs 1, 2, 3, and 4). The metric for turning on middle node A,C is thus (4 covered UEs)/(2 cell) equals 2. According to the chosen metric, turning on middle node A would thus be preferred to middle node A,C because it offers a higher metric. In some embodiments, there is a preference turning on middle node A instead of middle node A,C, since turning on A covers three UEs per activated cell as opposed to two UEs per activated cell in the case of node A,C. In some embodiments, the algorithm applies the same metric computation for each middle node in FIGS. 28A-28B. Inspection reveals that the algorithm would select to activate middle node Z. Indeed Z has the highest metric value of 4 among all the middle nodes in FIGS. 28A-28B. Turning on middle node Z requires turning on 1 cell on the left (Z) and covers 4 UEs on the right (UEs 3, 4, 5, and 6). Hence turning on Z would result in the highest number of covered UEs/per activated cell among all the options. Upon selecting middle node Z, the algorithm adds the associated cells on the left (i.e., cell Z) to the coverage set of cell and proceeds to the next step to cover more UEs.

FIG. 29 shows the next step in the algorithm, i.e, after node Z was turned on and UEs 1,2,3 and four have been covered. As shown in FIG. 29, only two UEs remain uncovered: UEs 1 and 2. Middle node A requires turning on 1 cell on the left (cell A) and covers both remaining uncovered UEs on the right (UEs 1 and 2), resulting in a metric 2 which equals (2 covered UEs)/(1 cell on). Nodes A,C and A,B,C result in lower metrics: turning any of these node on covers the two remaining UEs but to do so it requires turning several cells on. Node B,C on the other hand has a metric of 0 as it does not cover any of the remaining uncovered cells. As a result, the algorithm selects middle node A and adds the corresponding cells on the left (i.e., cell A) to the coverage set. Since no more UEs (nodes on the right) remain uncovered after the application of the second algorithmic step (shown on FIG. 29), the algorithm outputs the coverage set of cells {A,Z} and terminates.

FIG. 1B is a flow diagram of some embodiments of a process for constructing a and using a tripartite graph. The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 1B, the process is similar to that of FIG. 1A with the exception that after receiving the wirelessly transmitted measurement reports from the UEs, the process includes determining a list of cells that are options for use in providing coverage for each UE in the measurement reports and converting each neighbor PCI reported in the measurement reports that is in the list of the cells into a set of one or more neighbor cells (processing block 101A). In some embodiments, then the tripartite graph is created using the set of one or more neighbor cells that result from the conversion, and the rest of the process continues in the same way as FIG. 1A.

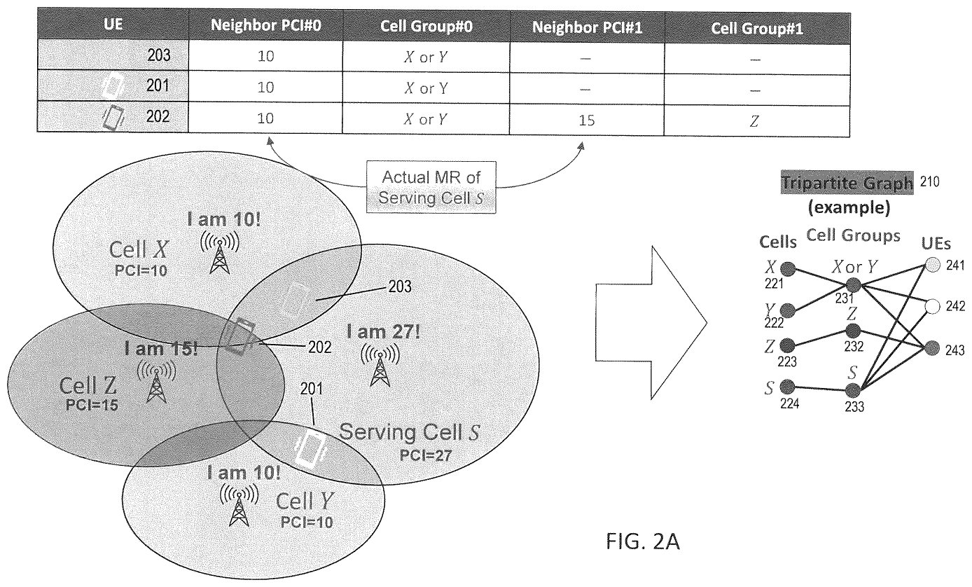

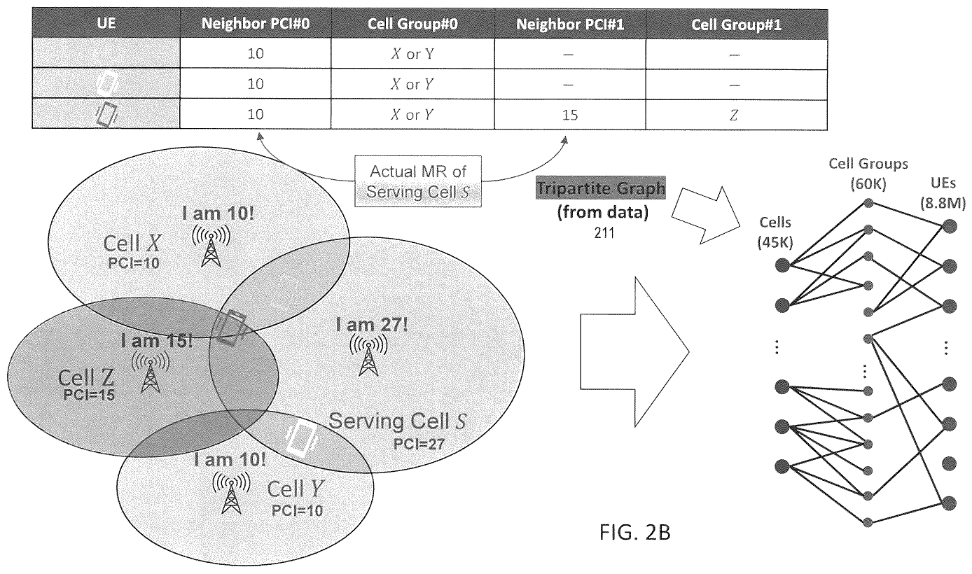

FIGS. 2A and 2B illustrate a coverage problem. Referring to FIG. 2A, serving cell S provides coverage for UEs 201, 202 and 203. Cell X could potentially provide radio coverage to UE 202 and UE 203, cell Z can potentially provide coverage to UE 202, and cell Y can potentially provide radio coverage to UE 201. Cell X and cell Y have PCIs equal to 10, while cell Z has a PCI equal to 15. As mentioned above, the PCIs do not exactly identify the cell, so there is an ambiguity as to which cells are neighbors of the service cell S.

As set forth in table in FIG. 2A, the neighbor PCI for UEs 201-203 is a cell with a PCI equal to 10 and includes a cell group having X or Y. UE 202 also has a neighbor PCI equal to 15 and includes a cell group having only cell Z. The neighboring PCIs are provided in the actual measurement reports (MRs) sent by UEs 201-203 to the serving cell S. Using this information, the tripartite graph 210 includes nodes 221-224 associated with cells X, Y, Z and S, respectively. Tripartite graph 210 also includes nodes 241-243 that represent UEs 203, 201, and 202, respectively. The cell groups are identified with using nodes 231-233. Node 231 represents cell group X or Y, node 232 represents cell group Z and node 233 represents cell group that includes serving cell S.

Using this tripartite graph 201, a coverage algorithm is applied to determine which set of cells can cover UEs 201-203, thereby enabling the possibility of placing serving cell S into a reduced power consumption state, while still maintaining radio coverage for all UEs 201-203. In this example, a determination may be made as to whether UEs 201-203 can receive radio coverage from cells X, Y, and Z, thereby enabling serving cell S to be placed into a reduced power consumption state.

While the tripartite graph 210 in FIG. 2A has a limited set of nodes, in actuality the tripartite graph can be quite large when taking into account all the cells, all the cell groups and all the UEs in the mobile network. For example, as shown in FIG. 2B some tripartite graphs 211 can include 45,000 cells, 60,000 cell groups and 8.8 million UEs. This makes determination of coverage much more difficult.

Because the actual numbers of cells and UE and potential cell groups is so large, in some embodiments, processing logic determines neighbor cells that can potentially be offloading options for each UE in the measurement reports and converts each reported neighbor PCI to a list of one or more likely neighbor cell IDs (ECIs) of cells for offloading. In some embodiments, the associated neighbor EARFCN (indicative of the neighbor frequency band) is also reported by the UE together with each neighbor PCI. The additional frequency-band information can be used to restrict the selection of likely neighbors only among cells broadcasting the given (neighbor) PCI value and operating on the frequency band specified by the neighbor EARFCN value. Note that for purposes herein a cell group can be identified as a (PCI, {ECI}) pair and these terms can be used interchangeably. Then processing logic creates a tripartite graph using the list of likely neighbor ECIs for each UE in the MRs.

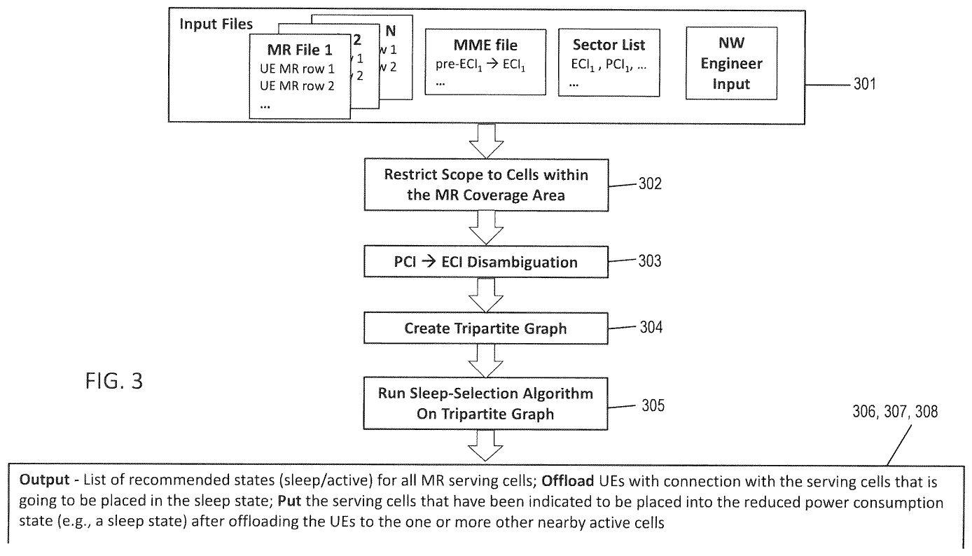

FIG. 3 is a flow diagram of some embodiments of a process for creating a tripartite graph and using it for determining which cells to place into a reduced power consumption state (e.g., a sleep state). The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

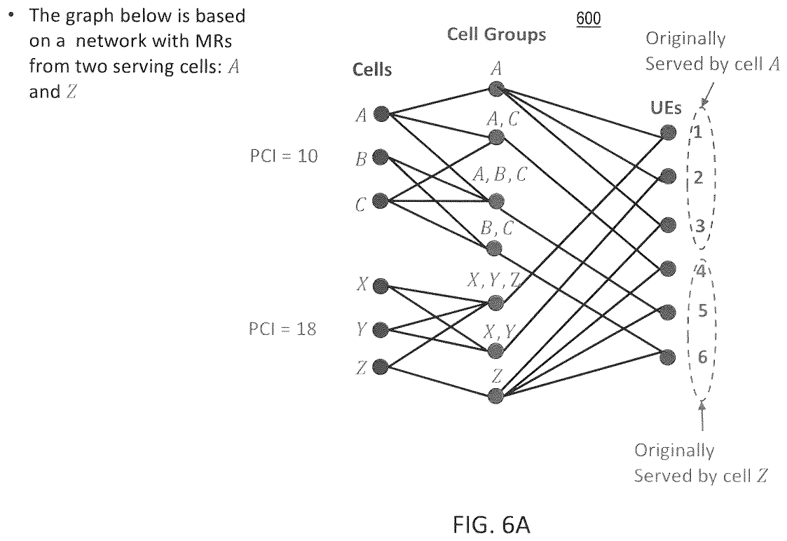

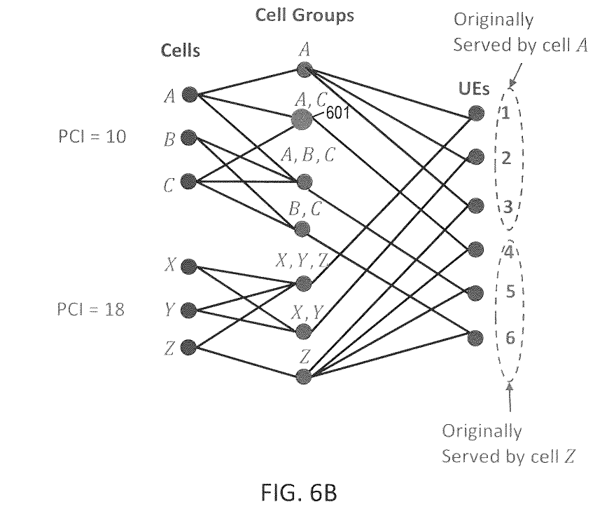

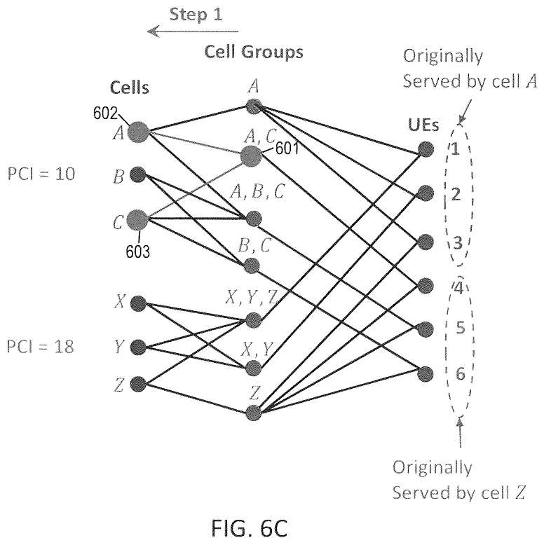

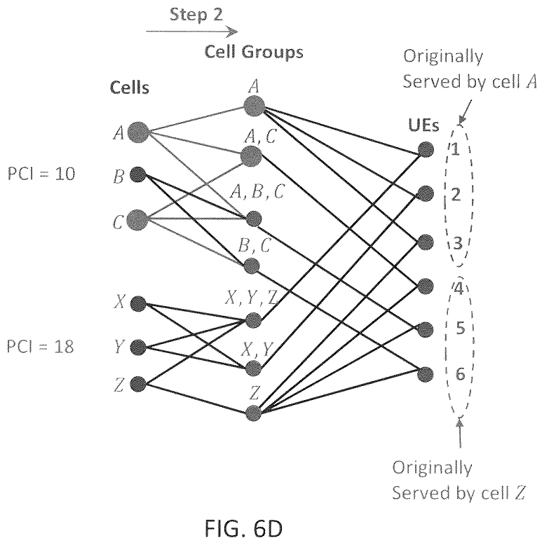

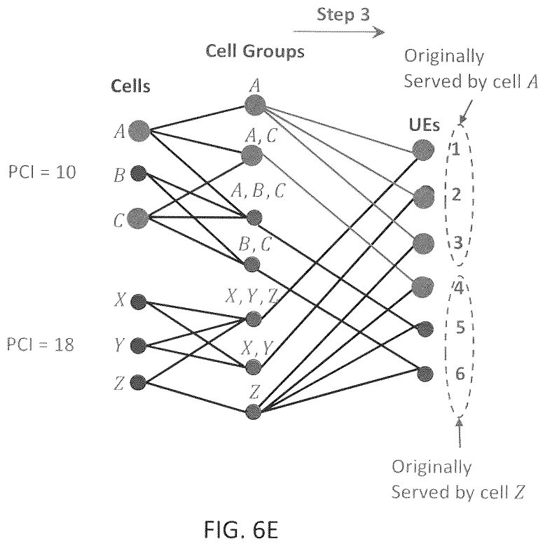

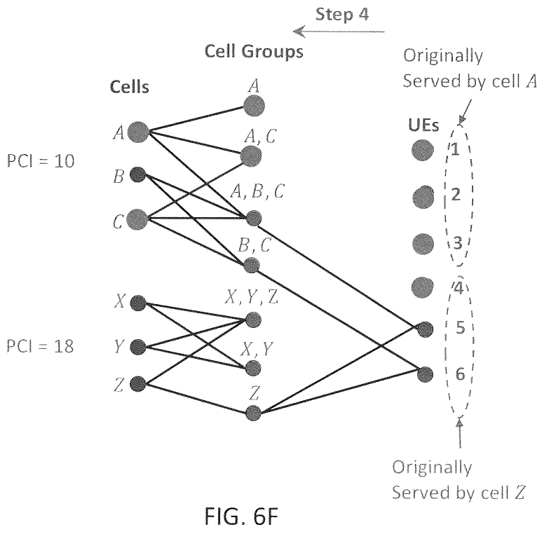

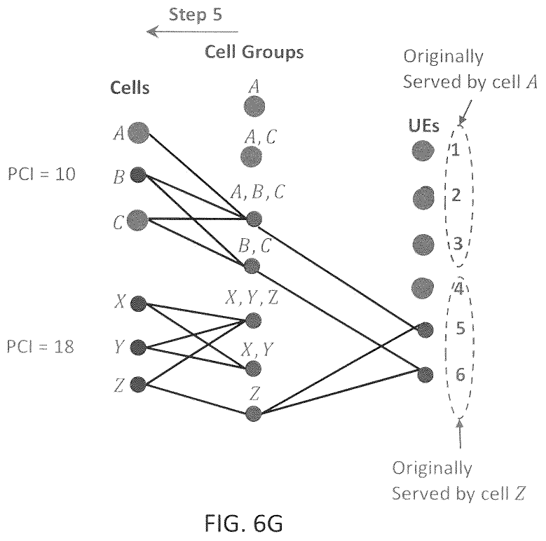

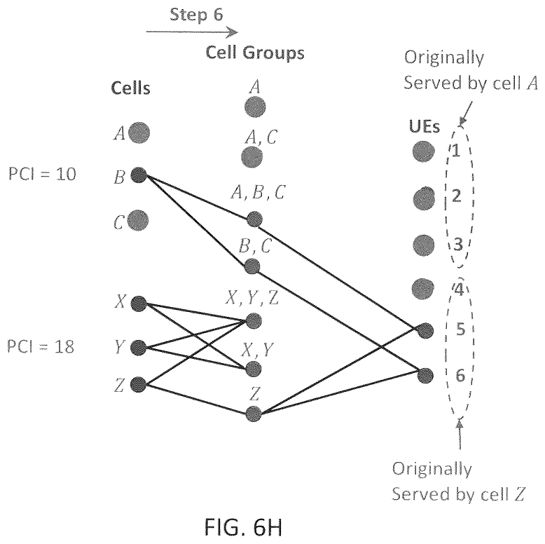

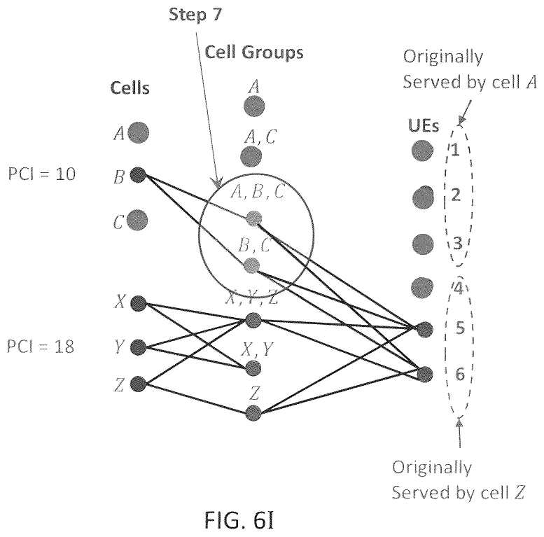

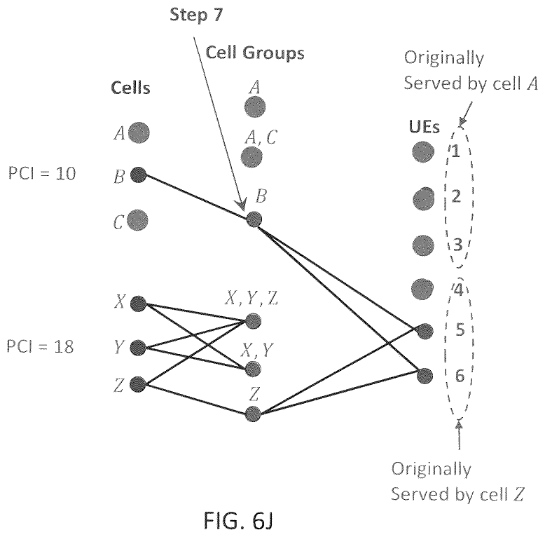

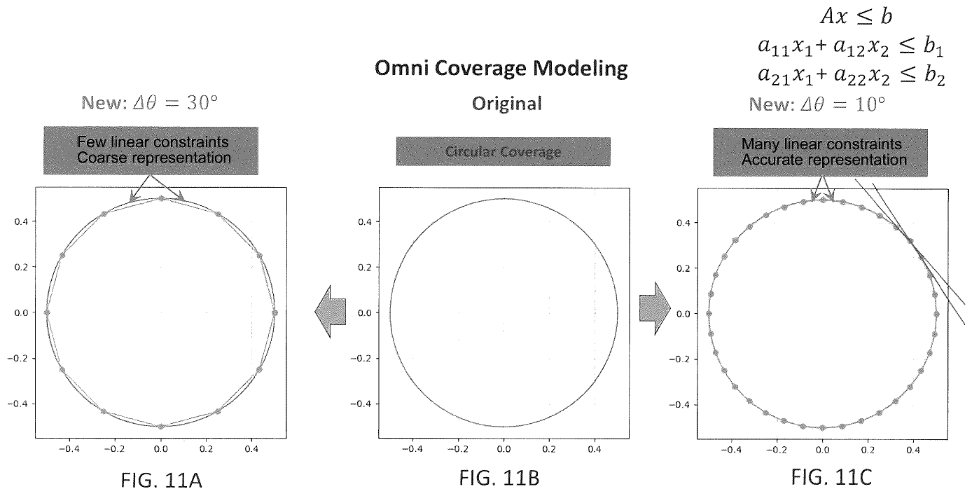

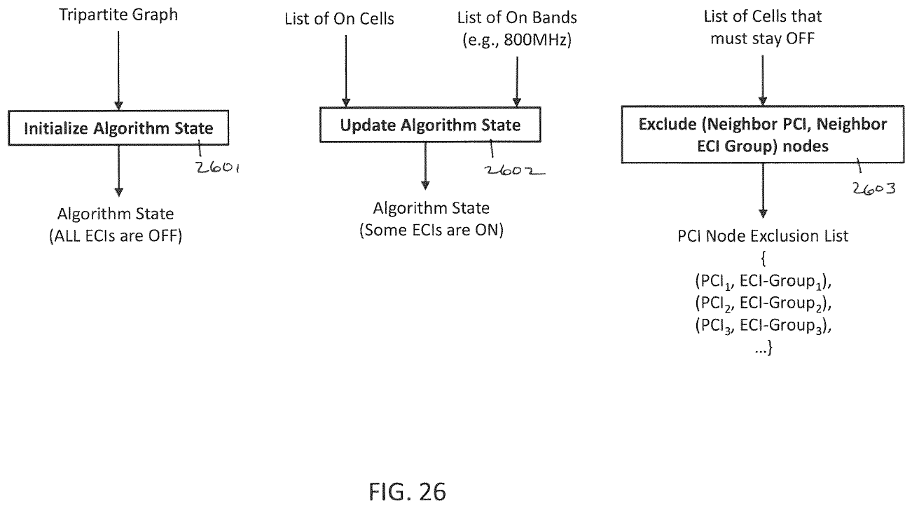

Referring to FIG. 3, the process begins by processing logic receiving input files (processing block 301). In some embodiments, the input files include the measurement reports from the UEs, a mobility management entity (MME) file (containing pre-ECI₁ to EC₁, etc.), a sector list (that includes ECIs and PCIs in sectors), and a network (NW) engineer input. In some embodiments, the input file only includes a subset of these items. In some embodiments, the sector list provides deployment information for each cell, including ECI, PCI, EARFCN, frequency band and antenna deployment parameters such as access point latitude and longitude, antenna azimuth and elevation, beam width, transmission power, etc. These parameters can be used to convert neighbor PCIs to likely neighbor cells. In some other embodiments, a subset of these are used to convert neighbor PCIs to likely neighbor cells. In some embodiments, MME file captures handovers from source cells to destination cells across the day and can be used to further improve the list of likely neighbors: if a likely list of several UEs served by some cell S (and corresponding to some neighbor PCI value P) has two cells, X and Y, and if there are many handovers between cell S and a cell Z (with PCI value also equal to P), then an assumption can be made (and acted upon by the processing logic) that cell Z is also a neighbor of S, so the likely list of neighbor cells with PCI value P can be augmented to {X,Y,Z}. In some embodiments, these inputs include specifying parameters for the coverage-sector overlap identification algorithm (see, for example, FIGS. 11-14, and FIGS. 16B-25), which cells and bands to keep on and which cells to keep off (FIG. 26), which graph (standard/extended) and algorithm to use (see, for example, FIGS. 6-8), etc. Using the input files, processing logic restricts the scope of the process to cells within the measurement report coverage area (processing block 302). In this way, the module determines all cells that are potentially offloading options for each UE in the MRs.

Next, processing logic performs PCI to ECI disambiguation (processing block 303). As part of the PCI to ECI disambiguation, processing logic converts each reporting neighbor PCI to a list of one or more likely ECIs. These ECIs identify neighbors cells for potentially offloading UEs from a serving cell. After performing the PCI to ECI disambiguation, processing logic creates a tripartite graph using the list of likely neighbor ECIs for each UE in the report (processing block 304). After creating the tripartite graph, processing logic runs a sleep selection algorithm or other algorithm (e.g., other greedy algorithm) on the tripartite graph (processing block 305). In some embodiments, the sleep selection algorithm is a coverage algorithm that is run on the tripartite graph with a goal of providing coverage to all UEs in the report with the least number of active cells.

After running the coverage algorithm, processing logic outputs a list of recommended states for all MR serving cells (processing block 306). In some embodiments, the recommended states include a sleep state or an active state to indicate that a serving cell is to go into the sleep state (a reduced power consumption state) or an active state, respectively, where the serving cell continues to serve UEs with coverage. In some embodiments, the process also includes offloading the set of UEs having a connection with the serving cells that is going to be placed in the sleep state to one or more other nearby active cells (processing block 307) and putting the serving cells that have been indicated to be placed into the reduced power consumption state (e.g., a sleep state) after offloading the UEs to the one or more other nearby active cells (processing block 308).

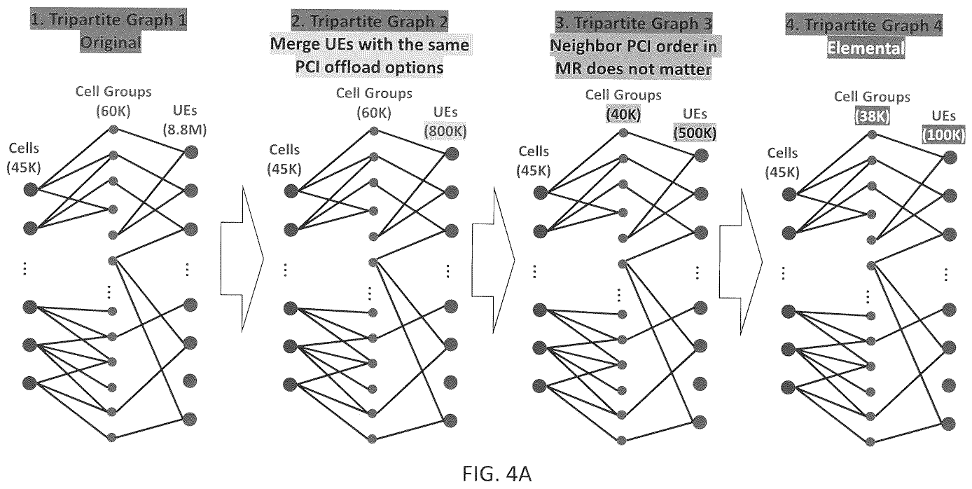

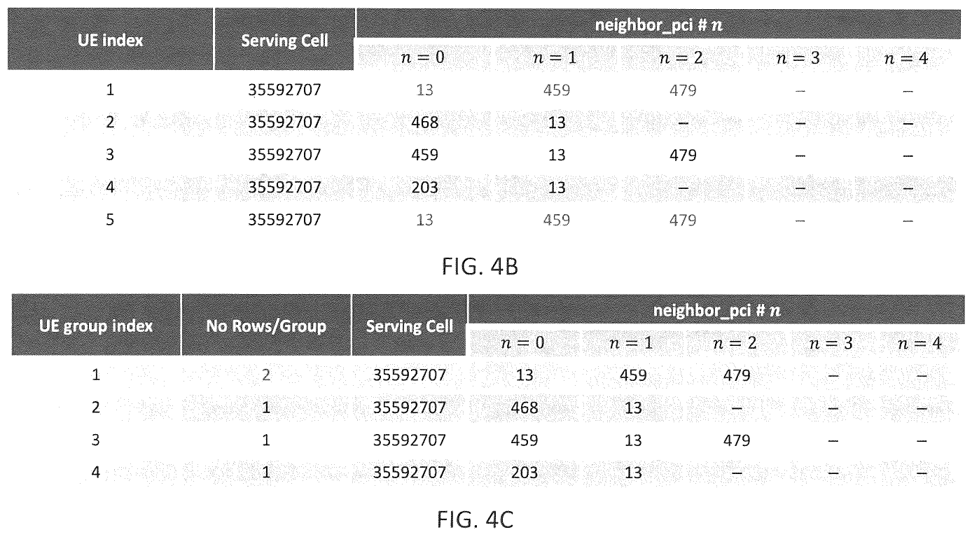

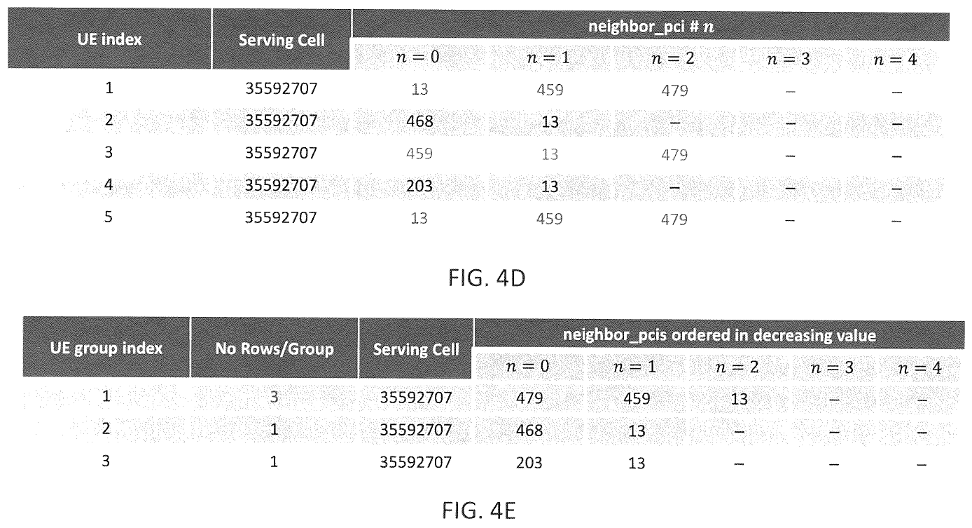

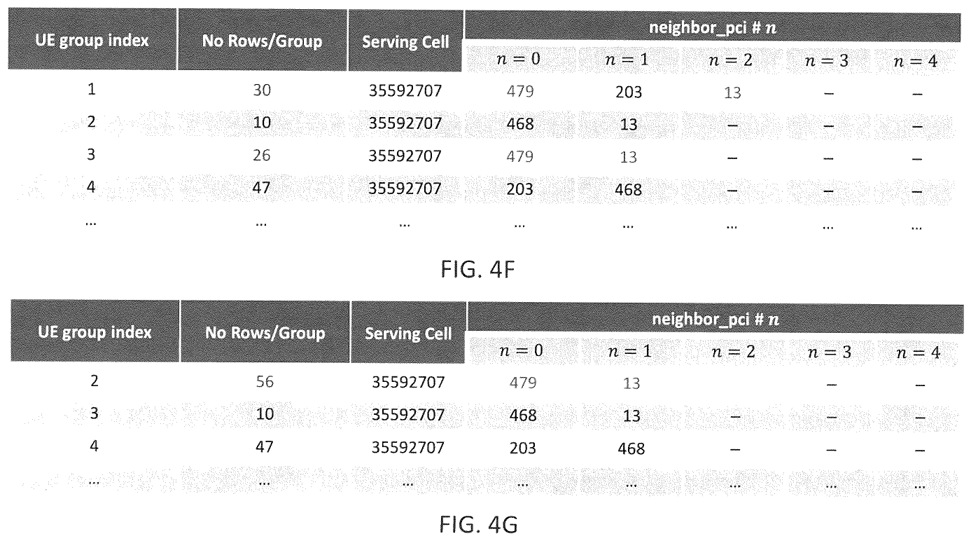

Given the numbers of cells and UEs in a typical wireless communication system, the tripartite graph may be very large. FIG. 4A illustrates the original tripartite graph having 45,000 cells, 50,000 cell groups and 8.8 million UEs. There are a number of ways to reduce the size of the tripartite graph to make it easier to apply a coverage algorithm to the graph in order to determine cells to which to offload UEs while powering down their serving cells.

In some embodiments, a tripartite graph can be reduced by merging UEs with the same offload options as indicated by the PCIs. For example, FIG. 4B illustrates a table that provides ordered PCIs from the MRs. Referring to FIG. 4B, there are five UE indices shown with the same serving cell and a list of PCIs that are contained in the MR for each of the UEs identified by the UE index. For example, the first UE, identified UE index 1 in row 1 has a serving cell identified by number 35592707 and has three neighboring cells with PCIs of 13, 459, and 479.

In order to reduce the original tripartite graph to tripartite graph 2 in FIG. 4A, those UEs having the same neighboring PCIs can be combined into a group. In this case, UEs identified by index 1 and 5 in FIG. 4B have the same neighboring PCIs. Therefore, these two UEs can be grouped together. FIG. 4C illustrates a table showing the groups grouped together. As a result, shown in tripartite graph 2, while the cells still equal to 45 k, the cell groups equal to 60 k, and the UEs have been reduced to 800 k (down from 8.8 million).

In some embodiments, tripartite graph 2 can be reduced further to tripartite graph 3 in FIG. 4A by taking into account that the neighboring PCI order in the MRs does not matter. For example, in FIG. 4D, the original MRs provided ordered PCIs sets. Referring to FIG. 4D, the UE identified by UE index 1 has neighboring cells identified by PCIs 13, 459 and 479. Similarly, the UE identified by UE index 3 has neighboring PCIs identified by PCI numbers 459, 13 and 479. Lastly, the UE identified by UE index 5 has neighboring cells identified with PCI numbers 13, 459 and 479. Thus, UEs 1, 3 and 5 all have the same neighboring cells based on the PCIs in the table even though they are not in the same order. In this case, the graph can be reduced by ignoring the order of the PCIs and combining those UEs into a single group that have the same neighboring cells.

In some embodiments, these neighboring PCIs are ordered in decreasing value, though this is not required. One advantage of having the neighboring PCIs ordered in decreasing (or increasing) value for each UE instance is that this ordering enables faster checking in software of whether two UE instances are equivalent in terms of likely neighbors. For example, consider two PCI tuple examples: (100, 300, 250) & (250, 100, 300). Visually, these tuples correspond to the same set of neighbor PCI values. Reordering all tuples in increasing [or decreasing] order yields for both sets the same tuple (100, 250, 300) [or, (300, 250, 100)] and the tuples can therefore immediately declared as equivalent.

An example of the resulting table is shown in FIG. 4E where the UE group identified by the UE group index 1 has three rows and has neighboring cells identified by PCIs 479, 459, and 13. The resulting tripartite graph 3 shown in FIG. 4A shows that while the cells are still 45 k in number, the cell groups have been reduced to 40 k (down from 60 k in tripartite graph 2), and the overall number of UEs have been reduced to 500 k (down from 800 k in tripartite graph 2).

Tripartite graphs can be further reduced to an elemental level, such as shown in tripartite graph 4 in FIG. 4A. FIG. 4F illustrates the table showing a sample section of the compressed MR that yields a tripartite graph 3. As shown, the UE group identified by UE group index 1 and the UE group identified by UE group index 3 have some of the same neighboring cells as indicated by the PCIs. In this case, UE group index 1 has neighboring cells with PCIs equal to 479, 203 and 13, while UE group index 3 has neighboring cells identified by PCIs 479 and 13. Since 479, 203 and 13 include 479 and 13, then the UE group index having 479, 203, and 13 can be mapped to the group having neighboring cells identified by PCI numbers 479 and 13. In other words, the two groups can be combined. FIG. 4G illustrates a reduced chart with the combined group.

### Coverage Algorithms

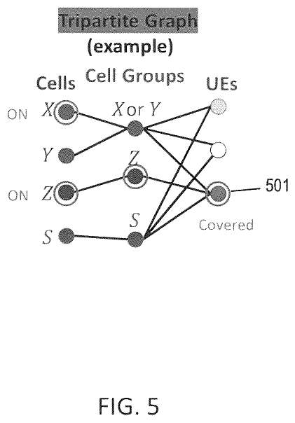

While applying coverage algorithms on the tripartite graphs, the state of the tripartite graph is such that any given on/off deployment of cells corresponds to a state of the nodes in the tripartite graph. In some embodiments, to obtain the state, a cell node is covered if the corresponding cell is on. A cell-group node is on if all of its cell neighbors are covered. This assumes that any such set of likely group is on and can serve UEs. A UE node is covered if at least one of its cell group neighbors is on. An example tripartite graph is shown in FIG. 5. Referring to FIG. 5, cells X and Z are on and cell group Z is on and the UE 501 is covered since its cell group Z is on.

There are number of coverage algorithms that can be applied on the tripartite graph to result in the state information that can be used for ON/OFF deployment of cells. For example there are families of greedy algorithms that may be applied on the tripartite graph. In some embodiments, one of the greedy algorithms, referred to herein as an incremental algorithm, can be applied on the tripartite graph. In some other embodiments, a multi-candidate selection algorithm can be used. In yet some other embodiments, other algorithms can be used on the tripartite graph to obtain the state information used for deployment decisions.

FIGS. 6A-6J illustrate an example of a coverage algorithm that is applied on a tripartite graph. The coverage algorithm is performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 6A, the tripartite graph 600 includes cells A-C and X-Z along with UEs 1-6. UEs 1-3 originally served by cell A, while UEs 4-6 were originally served by cell X. Tripartite graph 600 is generated from MRs from two serving cells A and Z. The cell groups are represented by nodes and includes cells groups A; A,C; A,B,C; and B,C. Cell groups also include cell groups X,Y,Z; X,Y; and cell group Z. With respect to the left graph edges and nodes therein, to turn a cell group on, all of the cells connected to the cell group by an edge are turned on. With respect to the right graph edges, any edge from a cell group to a UE covers the UE.

In some embodiments, all the cells in the tripartite graph are initially off (e.g., in sleep mode, etc.) and the application of the coverage algorithm begins by turning a single cell group on. In this case, the cell group A,C represented by node 601 is turned on. FIG. 6B illustrates a single cell group node being turned in the tripartite graph.

With cell group A,C on, the first step is to determine which cells need to be turned on in order to turn on cell group A,C. The processing logic determines which cells to turn on in order to turn on cell group A,C. In this case, to turn on cell group A,C, processing logic turns on cell A and cell C. FIG. 6C illustrates cell group A,C represented by a node 601 is turned on, and cells A represented by node 602 and cell C represented by node 603 are turned on. After turning on cells A and C, processing logic determines which other cell groups to turn on due to the turning on of cells A and C may turn on additional cell groups. If cells A and C are on, processing logic turns on cell groups A and A, C (i.e., not just cell A,C). In other words, after turning on cell group A,C, which causes cells A and C to be turned on, processing logic turns on cell group A as well. Note that cell groups A,B,C and B,C are not on because cell B is still off. FIG. 6D illustrates cell group A and cell group A, C being turned on.

After turning on the additional cell groups, processing logic determines which UEs are covered by those cell groups that have been turned on. Since cell groups A and A,C are on, those cell groups cover UEs 1, 2, 3, and 4. This is illustrated in FIG. 6E.

After determining which UEs are covered, processing logic deletes the covered UEs and their edges from the tripartite graph as these are no longer needed. In the example, UEs 1, 2, 3, and 4 are already covered, and therefore their nodes are no longer needed and can be deleted from the graph. Similarly, all the edges of UEs 1, 2, 3, and 4 are no longer needed and can be deleted. FIG. 6F illustrates the covered UEs and their edges have been deleted from the tripartite graph.

After deleting the covered UEs and their edges as specified above, processing logic deletes the on cell group nodes and their edges because they are no longer needed. Since cell groups A and A, C are no longer needed, the edges from cell groups A and A,C are no longer needed and can be deleted. FIG. 6G illustrates the tripartite graph without on cell-group nodes and edges.

After deleting on cell-group nodes and edges, processing logic deletes the on-cell nodes and edges, as these are no longer needed. In the example, cells A and C are also no longer needed and the edges of cells A and C are no longer needed. FIG. 6H illustrates the on-cell nodes and edges being deleted from the tripartite graph. After deleting the on cell nodes and edges, processing logic merges cell groups that are connected to the same cells. Since cells A and C are on, cells groups A,B,C and B,C become cell group B. Thus, processing logic merges these two cell group nodes and renames the resulting node B. Cell groups A,B,C, and B,C are both connected to UEs to cell B and therefore are merged. FIG. 6I illustrates merging cells groups connected to the same cells.

After merging cell groups connected to the same cells, processing logic merges cell-group nodes connected to the same cells. These cell groups can be renamed to reflect the cells that would turn them on. Note that in some embodiments merging is not applied. Turning on cell node B,C will also turn on node A,B,C because cells A,C are already on. Note that merging yields a simpler graph but requires computation. FIG. 6J illustrates resulting tripartite graph after merging cell-group nodes connected to the same cells. As shown in FIG. 6J, the edges for cell groups X,Y,Z and X,Y have been removed from their connections to UE 5 and 6. (Cell group X,Y has already had the edges removed).

As a result, the process indicates that cells A, B and C can cover all of the UEs 1-6 and cells X, Y and Z can be placed in a reduced power consumption state (e.g., a sleep state).

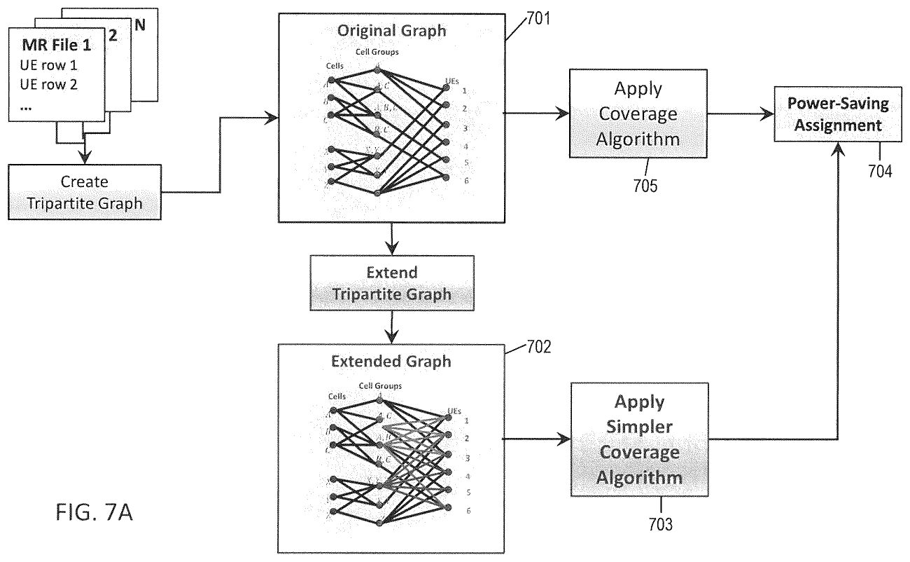

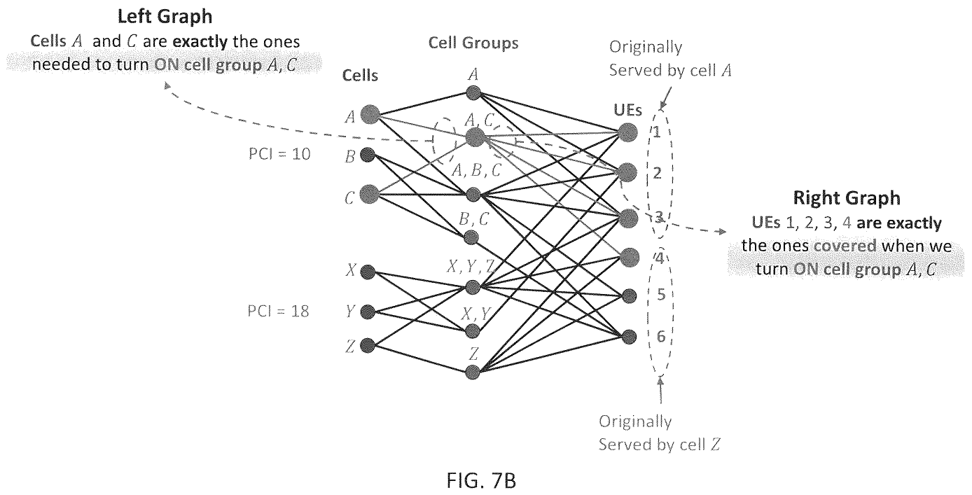

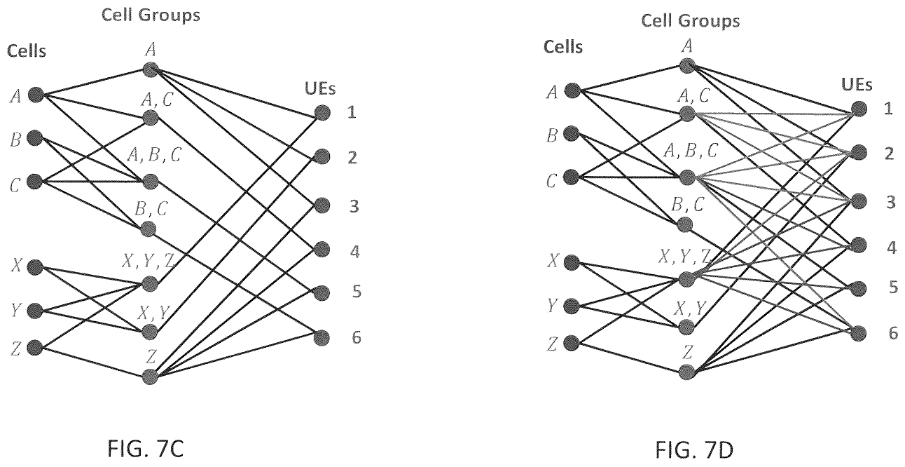

In some other embodiments, extended tripartite graphs are used. In the extended tripartite type graph, a UE can be covered by a cell group if and only if the UE has an edge to that cell group. For example, in this case, an original tripartite graph shown in FIG. 7A as tripartite graph 701 can be extended by processing logic to produce extended graph 702. While in some embodiments, the original tripartite graph directly represent the reported PCIs, with every connection between a UE and a middle node representing either of the following: 1a) coverage provided by one of the neighbor PCIs reported by the UE (the middle node in that case represents the group of likely neighbor cells with that PCI); or 1b) coverage provided by the serving cell of the UE (the middle node in that case represents a group comprising the serving cell only), the original graph does not represent all coverage options for each UE. For example, a UE can be provided coverage by its serving cell X, but also any other middle node representing a group of cells that include X. Indeecd, such a middle node would correspond to a neighbor PCI reported in a nearby cell to X (and where the neighbor PCI reported coincides with the PCI of X). In contrast, in some embodiments, the extended graph comes from further post processing and represents all the coverage options per UE (in terms of which groups of cells can cover each UE). In such a case, a simpler coverage algorithm 703 can be applied to determine the power saving assignments and states 704, in contrast to applying the typical coverage algorithm 705 to the original tripartite graph 701 to determine the power saving assignments 704.

An extended tripartite graph simplifies the coverage algorithm design. FIG. 7B illustrates an example of an extended tripartite graph. In FIG. 7B, in the left graph, cells A and C are exactly the ones needed to turn on cell group A,C. In the right graph, UEs 1, 2, 3, and 4 are exactly ones covered when cell group A,C are turned on. FIGS. 7C and 7D illustrate an original tripartite graph and an extended tripartite graph, respectively. To initialize the extended tripartite graph, for each cell group, edges are added to capture the extended tripartite graph. In this case, cell group A covers UEs 1, 2, and 3 and A or C covers UEs 1, 2, and 3 as well.

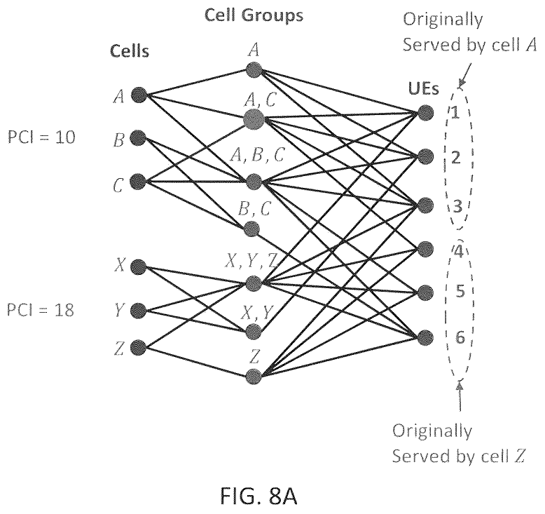

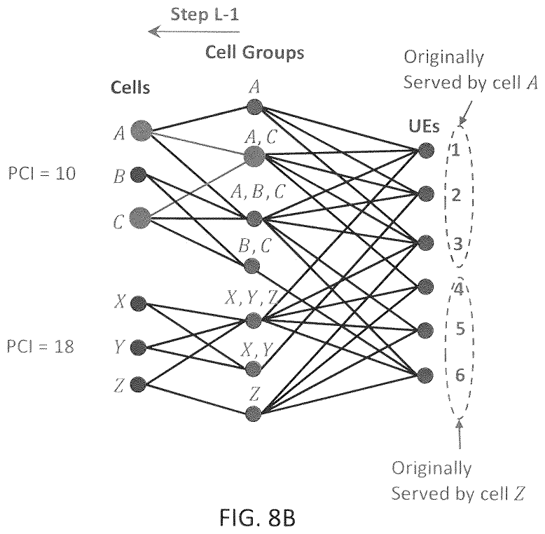

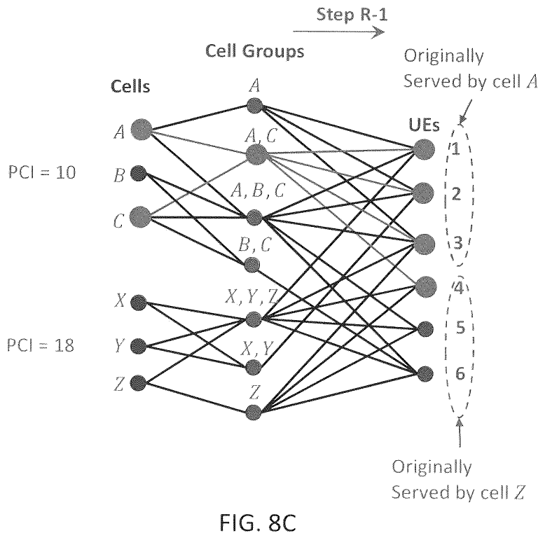

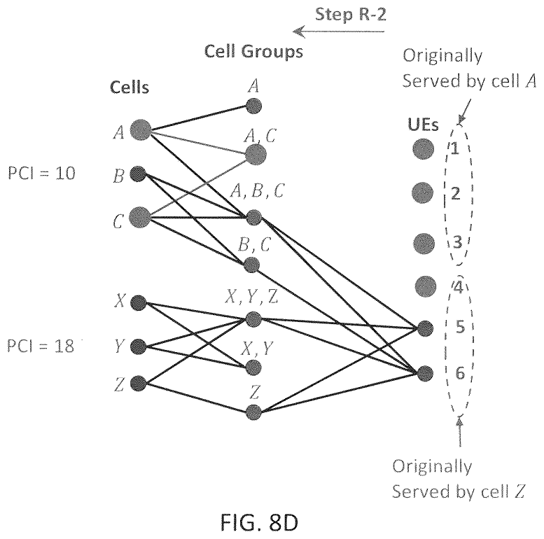

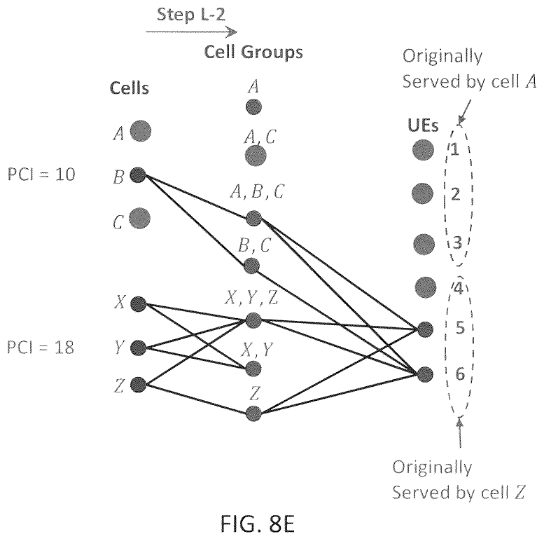

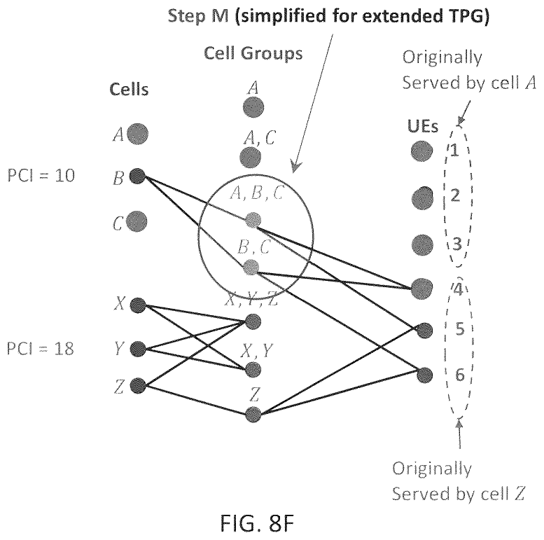

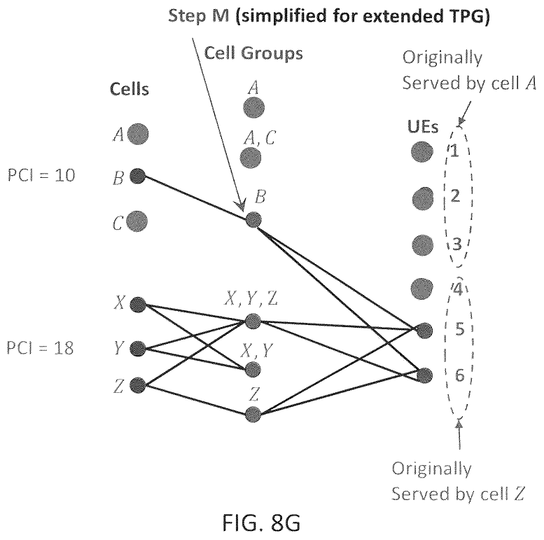

Using the extended graph, processing logic turns on a single cell group. In some embodiments, all the cells are assumed initially to be in a sleep mode. FIG. 8A illustrates an example of a single cell group being on. Referring to FIG. 8A, processing logic turns on cell group A,C. In response to this, processing logic determines which cells must be turned on. An example, is illustrated in FIG. 8B since processing logic turns on cell group A,C, processing logic turns on cell A and cell C. At this point, processing logic determines which UEs are covered by turning cell group A,C. Since nodes A,C is on, UEs 1, 2, 3, and 4 are covered (see FIG. 8C).

Note that this operation of determining which UEs are covered can be performed independently of determining which additional cells must be turned on in response to the turning on of a cell group. In other words, these operations can be performed in a reverse order. Furthermore, these two initial operations of determining which cells have to be turned on in response to turning on a cell group and then determining which UEs are covered are the same as being performed on a standard tripartite graph. However, these operations are performed in order in the standard graph but not so in the extended graph.

After determining which UEs are covered, processing logic deletes the covered UEs and their edges from the tripartite graph. In this example, UEs 1, 2, 3, and 4 are already covered so their nodes are no longer needed and can be deleted from the graph. Similarly, all the edges of UEs 1, 2, 3, and 4 are no longer needed and can be deleted. FIG. 8D illustrates the tripartite graph after deleting the nodes for UEs 1, 2, 3, and 4 as well as their edges.

After deleting the covered UE nodes and their edges, processing logic deleted the covered cells and their edges. In this example, cells A and C are no longer needed and therefore the edges of cells A and C are deleted. FIG. 8E illustrates the example of the tripartite graph with the cells A and C as well as their edges being deleted.

Next, processing logic merges cell group nodes that have the same edges. This step removes additional redundancy as cell nodes with the same edge connections (left and right) are eliminated. In the example, cell groups A,B,C and B,C share the same edge sets. Therefore, there's only a need to keep track of one these nodes and its edges. FIGS. 8F and 8G illustrate an example of the tripartite graph before and after, respectively, merging cell group nodes with the same edges.

Note that in some embodiments an extended graph can also be expressed as a tripartite graph formed from a combination of two different standard bipartite graphs (used to represent standard set coverage problems) where the source nodes in each case are the middle nodes. That is, the extended graph can be created by combining two separate bipartite graphs, each describing a standard set coverage problem:
1. a right graph with source nodes being the second set of nodes (i.e., the cell groups), and destination nodes being the third set of nodes (i.e., the UEs). Such a bipartite graph describes a standard set coverage problem. A destination node (UE) is ON (covered) if and only if a source node connected to it by an edge is ON; and
2. a left graph with source nodes being again the second set of nodes (i.e., the cell groups), and destination nodes being the first set of nodes (i.e., the individual cells). Note that this graph is the left bipartite subgraph flipped horizontally. A destination node (cell) is on if and only if a source node connected to it with an edge (corresponding to a cell group containing this cell) is on. As for the algorithm that is applied to the these graphs, in some embodiments, two “coupled” coverage set algorithms are run on these graphs. When it is required by the algorithm to compute the metric impact of turning on any given middle node (which is a source node for both graphs), the algorithm first finds the nodes that this middle node covers on the left side (cells) and on the right side (UEs), and uses the total numbers of nodes covered to the left and to the right to compute the desired metric such as described above.

Thus, in this manner, using the regular or extended tripartite graphs result in an equivalent output. However, an extended tripartite graph is usually preferred, as it typically provides a great reduction in algorithm runtime (by a factor of 60 in some experiments) for a reasonable increase in memory footprint (e.g., by a factor 2-3).

### Neighbor Cell Determination

In some embodiments, the process of determining which cells to offload UEs to and which cells to power down is based on identifying which are the active cells that are neighbors of the serving cell that is currently serving the UEs that are to be offloaded. While the tripartite graph can be constructed with all the cells in the mobile network based on PCIs in the MRs from the UEs and then processed with a coverage algorithm to determine the active neighbor cells to offload UEs from a serving cell that is to be powered down, the tripartite graph can be very large as the PCIs do not exactly identify each cell. See FIG. 2B.

One way to reduce the size of the tripartite graph is to reduce the cells used in the tripartite graph to the set of likely neighbor cells. These likely neighbor cells would be identified by the cell IDs (ECIs). To identify the likely neighbor cells (e.g., the ECIs of the cells), a process of PCI to ECI disambiguation is performed. In some embodiments, disambiguating a set of PCIs includes determining which combination of neighbor cells could have produced a combination of PCIs in the UE MRs.

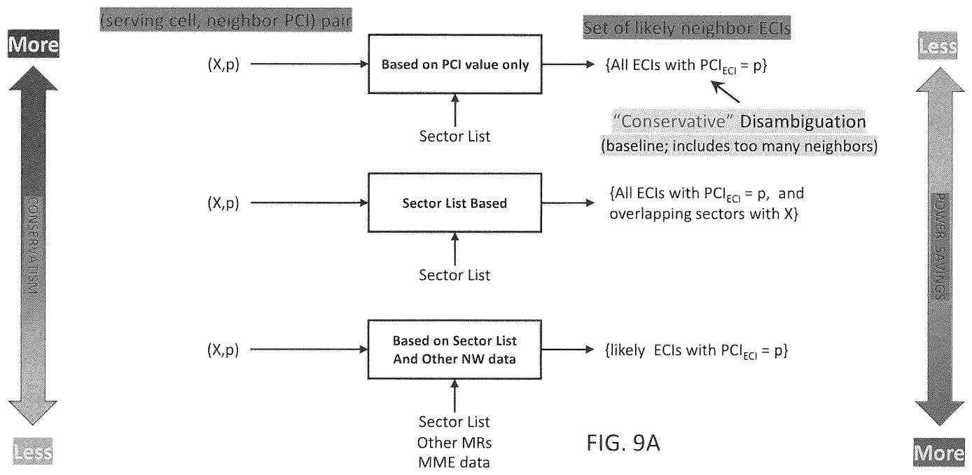

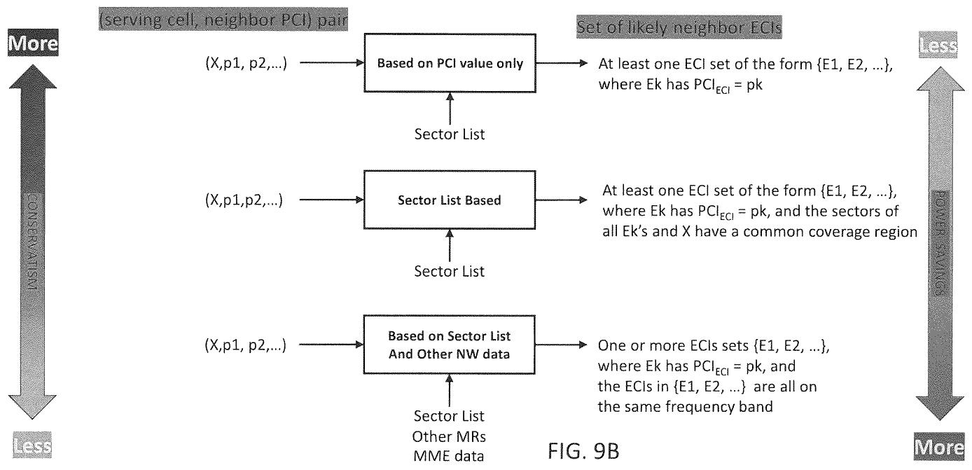

In some embodiments, the ECI disambiguation is done on a per cell (cell specific) basis. In this case, from the MRs, processing logic such as described above generates (serving cell, neighbor PCI) pairs that are input into the disambiguation process. Using the inputs, the processing logics generates a set of likely neighbor ECIs. In some embodiments, the processing logic uses these input pairs, along with a sector list, to determine the set of likely neighbor ECIs based on the PCI value only. For example, all ECIs with a PCI_{ECI}=p are determined to be the set of likely neighbor ECIs. In some other embodiments, the processing logic uses these input pairs, along with a sector list to generate a set of likely neighbor ECIs based on the sector list only. For example, in some embodiments, all the ECIs with a PCI_{ECI}=p and overlapping sectors with the serving cell are determined to be the set of likely ECIs for a cell. In yet some other embodiments, the processing logic uses these input pairs, along with a sector list, other MRs and MME data, to determine the set of likely neighbor ECIs based on a sector list and other network (NW) data. For example, the likely ECIs can be both ECIs with a PCI_{ECI}=p. FIG. 9A illustrates these different embodiments.

In some embodiments, the ECI disambiguation is done on a per UE (UE-specific) basis. In this case, from the MRs, the processing logic generates (serving cell, neighbor PCI1, neighbor PCI2, . . . ) tuples that are input into the disambiguation process. Using the inputs, the processing logics generates a set of likely neighbor ECIs. In some embodiments, the processing logic uses these input tuples, along with a sector list, to determine the set of likely neighbor ECIs based on the PCI value only. For example, in this case, the set of likely neighbors includes at least one ECI set of the form {E1, E2 . . . }, where Ek has PCI_{ECI}=pk. In some other embodiments, the processing logic uses these input tuples, along with a sector list to generate a set of likely neighbor ECIs based on the sector list only. For example, in this case, the set of likely neighbors includes at least one ECI set of the form {E1, E2 . . . }, where Ek has PCI_{ECI}=pk and the sectors of all Ek's and the serving cell have a common coverage region. In yet some other embodiments, the processing logic uses these input tuples, along with a sector list, other MRs and MME data, to determine the set of likely neighbor ECIs based on a sector list and other network (NW) data. For example, in this case, the set of likely neighbors includes one or more ECI sets of the form {E1, E2, . . . }, where Ek has PCI_{ECI}=pk, and the ECIs in {E1, E2 . . . } are all the same frequency band. FIG. 9B illustrates these different embodiments.

In some embodiments, this process of performing neighboring cell disambiguation includes determining a radio-coverage overlap between two or more cells. The two or more cells can include the serving cell of a UE and the one or more cells in a combination of neighbor cells based on reported PCIs. In some embodiments, determining the radio-coverage overlap comprises constructing a geometric coverage area for each cell and the combination of neighboring cells. The radio-coverage overlap can be a coverage overlap between two or more sectors. In some embodiments, constructing a geometric coverage area in the combination of neighboring cells includes constructing one or more convex polygons representing the geometric coverage area for each cell in the combination of neighbor cells. In some embodiments, constructing one or more convex polygons representing the geometric overage area for each cell in the combination of neighbor cells is performed using sector list information in one or more propagation models.

More specifically, in some embodiments, the determination of a coverage overlap and likely ECIs is performed as a “per (serving) cell” option with a goal of selecting a single set of likely ECIs for each neighbor PCI p value reported by UEs in a serving cell X, which can be used for offloading any UE group in the serving cell X that reports neighbor PCI p. For the per cell option, the inputs and outputs are as follows:
Input:
   X: serving ECI
   p: neighbor PCI value reported by UEs in X
   Yₚ: set of all ECIs with PCI=p
Output:
   Zₚ=Cov_overlap(X, Yₚ): subset of Yₚ, including only cells that overlap in coverage with X
      In this case, the size of the tripartite graph can be reduced to its elemental state without “information” loss. This information loss can be explained in an example. Assume in a cell, some UEs reported PCIs (10, 15) and others reported (10, 15, 20). With the per cell option, each PCI number is disambiguated considering coverage overlap with serving cell only, resulting in: 10->X1, X2, 15->Y1, Y2, and 20->Z. Hence, the neighbor-PCI list (10, 15) gets disambiguated to the likely-neighbor sets list ({X1,X2}, {Y1,Y2}) and the neighbor-PCI list (10,15,20) gets disambiguated to the likely-neighbor sets list ({X1,X2}, {Y1,Y2}, {Z}). Thus, the neighbor-PCI list (10,15,20) can be deleted from the graph because it is covered by the neighbor-PCI list (10,15). Also, the only way a coverage algorithm can cover a UE instance with neighbor-PCI list (10,15,20) is if it also covers UE instances that reported a neighbor-PCI list (10,15). With per-UE disambiguation, however, there are differences. Here, the neighbor-PCI list (10,15) might get disambiguated to the likely-neighbor sets list ({X1,X2},{Y1}), while the neighbor-PCI list (10,15, 20) might get disambiguated to the likely-neighbor sets list ({X1},{Y1}, {Z}). In this case covering a UE instance with neighbor-PCI list (10,15,20) does not cover cover a UE instance with neighbor-PCI list (10,15). The per cell option offers a good trade-off between algorithm complexity and power saving performance.

In some other embodiments, the determination of a coverage overlap and likely ECIs is performed as “per UE group” option with a goal of selecting sets of likely ECIs per PCI for each neighbor UE group n in serving cell X, with neighbor PCIs p₁, p₂, . . . , which can be used for offloading only specific UE group in the serving cell X. For the per UE option, the inputs and outputs are as follows:
Input:
   X: serving ECI
   n: UE group index
   {p₁, p₂, . . . }: neighbor PCI value reported by UEs in X
   {Yₚ₁, Yₚ₂, . . . }: all ECIs with PCIs p₁, p₂, . . . .
Output:
   Cov_overlap(X, Yₚ₁, Y_{P2}, . . . ): subset of overlapping combinations with serving ECI X
      This option allows in principle smaller likely ECI sets and thus can improve power savings. In some embodiments, the elemental graph is used for this option. However, for better power savings, however, it's best to work with the tripartite graph 3 of FIG. 4A.

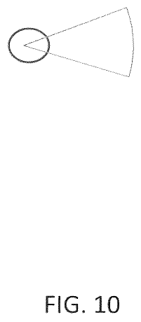

In some embodiments, coverage overlap is determined based on circular sectors. This sector overlap method is based on geometric regions. In this case, a cell's geometric coverage is represented as a union of an omni coverage region (e.g., a circle) and the region within a circular sector. FIG. 10 illustrates an example overlap.

In some embodiments, sector overlap is determined using linear constraints via omni-coverage modeling. In this case, each coverage region is represented as the union of convex regions, where each convex region can be described by a set of linear constraints. FIGS. 11A-C illustrate omni-coverage modeling using convex polygons. Referring to FIG. 11B, circular coverage is shown, such as is used in FIG. 10. However, FIGS. 11A and 11C illustrate the circle approximated in each case as a different convex polygon, each of which can be represented by linear constraints. In particular, the region contained by each convex polygon can be represented as the intersection of half planes, with defining lines along the segments of the polygon. Each such half plane can be represented by a single linear constraint. In the case of FIG. 11A, the representation is coarse with DO being equal to 30°, while in FIG. 11C, the representation is less course as the Dθ being equal to 10. Note that the techniques are not limited to using 10° and 30° and other Dθ can be used.

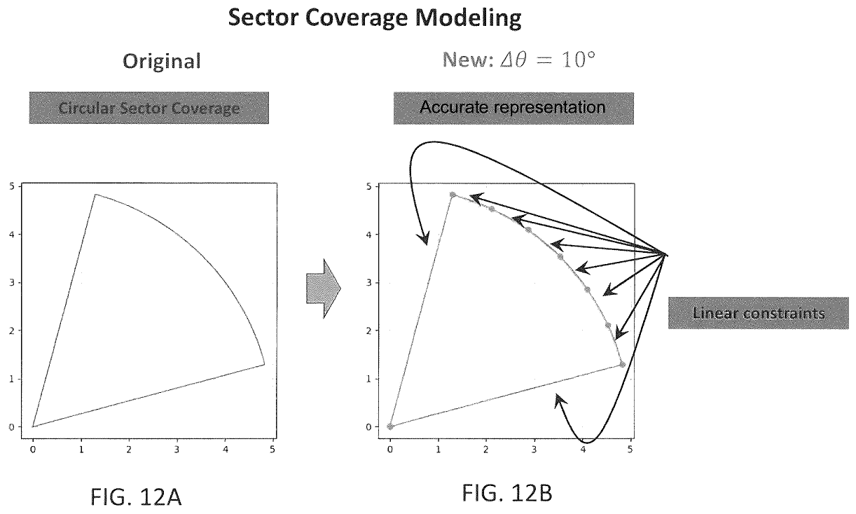

In some embodiments, at least part of the region of a cells coverage can be represented by one or more geometric sectors, each of which can be determined using linear constraints via sector-coverage modeling. In this case, the coverage regions is the union of convex regions, where each convex region can be described by a set linear constraints. In this case, a circular sector can be represented with linear constraints. FIGS. 12A and 12B illustrates an example of the use of linear constraints representing a circular sector. In the case of FIGS. 12A and 12B, the representation has Dθ being equal to 10°. Note that the techniques are not limited to using 10° and other Dθ can be used.

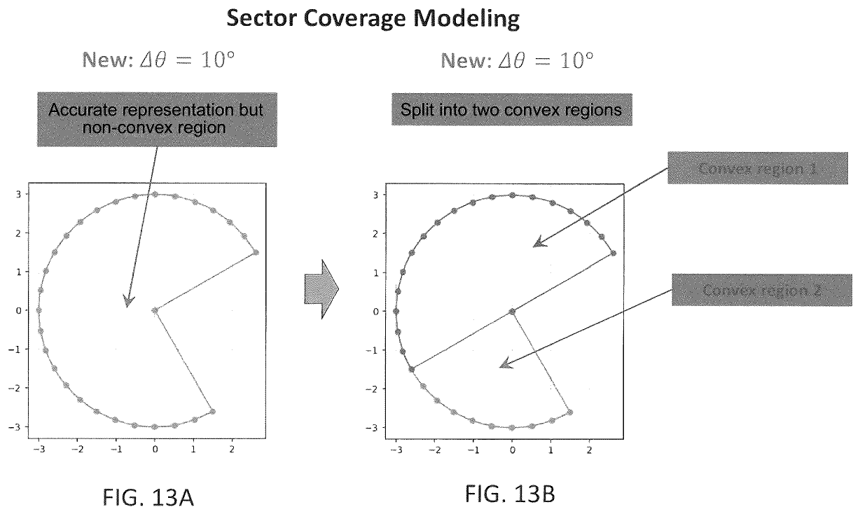

Note that the sector can be non-convex for wide sector modeling. This can be advantageous for wide beamwidths. In some embodiments, the non-convex sector is expressed as the union of two convex regions. FIGS. 13A and 13B illustrates an example of a non-convex region being represented as two convex regions 1 and 2.

In some embodiments, an algorithm to determine a sector overlap via linear constraints determines whether X₁, X₂, X₃ (and possibly X₄ . . . ) overlap [Xₙ has PCI value pₙ]. Given a coverage region of Xₙ where:

$${C}_{n} - {⋃}_{k} {C}_{n}^{( k )} ( union of convex regions ) , and$$

$${C}_{n}^{( k )} : All 2 D locations x , such that {A}_{n}^{( k )} x - {u}_{n}^{k} \leq 0 , with \{ {A}_{n}^{( k )} , {u}_{n}^{k} \} , describes the coverage constraints .$$

In this case, the algorithm, for each triplet combination of sectors

$${C}_{1}^{( k )} , {C}_{2}^{( j )} , {C}_{3}^{( m )} ,$$

is as follows:
Let (x,y) denote a UE location
Solve the following linear program (LP):
   Maximize_{over (x,y)}f(x,y)=x+y [or any other function of (x,y)]
   Subject to UE location (x,y) constrained to be in

$${C}_{1}^{( k )} and {C}_{2}^{( j )} , and {C}_{3}^{( m )} ,$$

If there is a solution to the LP (i.e., if the LP is feasible), then the sectors

$${C}_{1}^{( k )} , {C}_{2}^{( j )} , {C}_{3}^{( m )}$$

overlap; otherwise, they do not.

In some embodiments, the linear program returns as its solution one (and only one) of the following: Case 1: a pair of values (x*,y*) that yields the maximum value of f(x,y) among all (x,y) pairs that satisfy all the linear constraints; and Case 2: no solution is returned as the problem is infeasible as there is no (x,y) pair that satisfies all the linear constraints. In order to determine geometric sector overlap, it is thus only necessary to know whether the problem returns Case 1 or Case 2. Therefore, the choice of f(x,y) does not matter; if the solution returned corresponds to case 1 (problem is feasible), then there is a common region of coverage overlap among all the checked geometric sectors; if on the other hand the solution returned corresponds to Case 2, then there is no coverage overlap among all the checked geometric sectors.

In some embodiments, the algorithm tests all coverage-region triplets of the three cells in some order. When the algorithm finds coverage overlap in a triplet (i.e., a feasible LP), it stops and outputs an indication that coverage overlap was detected. If the algorithm goes through all triplets and does not find any triplet overlap (i.e., all LPs tested are infeasible), then the algorithm outputs an indication that no overlap was detected.

Note that geometric sectors are not an accurate representation of real radio coverage. Therefore, in some embodiments, the geometric coverage regions are conservative, but not too conservative. That is, in some embodiments, UEs are at the limit of actual radio coverage when the receive power is between −120 to −125 dBm, and the geometric sectors are parameterized via a parameter Prx_min intended to represent the minimum RX power at the UE guaranteeing coverage. Using Prxmin e.g., 15-20 dB below −125 dBm to create the sectors is an indirect way of increasing coverage and ensuring that any point of actual radio coverage is also included by the geometric coverage sector. Also, note that other algorithms can be used to solve the linear constraints.

In some embodiments, the algorithm for determining the sector overlap by linear constraints uses one or more additional algorithm parameters. For example, to determine a cell's coverage region, in some embodiments, the following parameters are used:
Sector list info: access point (AP) latitude and longitude, beam direction, beam width, transmit (Tx) power, antenna height, etc.
PL model: any appropriate PL model can be used. In some embodiments, such a PL model can be a PL model from the 3GPP specifications. In some other embodiments, the LP model can depend on the deployment scenarios (Urban Macro, Urban Micro, Rural, etc.).
User specified parameters:
   Rₙₒₘ: nominal omni-coverage radius for each cell (e.g., 0.25 km, or other settings of a different value per frequency band)

$${P}_{min}^{RX} : minimum receive power for coverage$$

Varied, starting from −120 dBm and decrementing by

$${P}_{step}^{RX} = 5 dB to e . g . , - 140 dBm$$

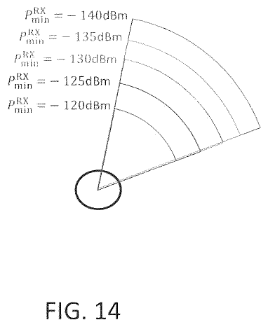

Usage example (see FIG. 14):

$$Set {P}_{min}^{RX} ← - 120 dBm$$

$$Set {P}_{inf}^{RX} ← - 140 dBm$$

$$Set {P}_{step}^{RX} ← 5 dB$$

Set found_ovelaping_combo←False [initialization for the loop below]
δθ: increase in beamwidth in degrees from the one specified in the sector list

$$δ θ = 0 in some embodiments$$

This parameter can be used to ensure coverage overlap is found for some (serving eci, neighbor pci) combinations
   These parameters work with the algorithm described above. Given Rₙₒₘ and the access point longitude and latitude, the circle (e.g., its center and radius) in FIG. 11B can be specified. The remainder of the parameters are used when representing sector coverage as in FIG. 14. Given values for

$${P}_{min}^{RX}$$

and δθ, and other sector list parameters like beam width beam direction, antenna height, location, the PL model is used to determine a sector (see FIG. 14). This sector is used as the start to design the polygon sector (either FIGS. 12A and 12B or FIGS. 13A and 13B). In some embodiments, a cell's geometric coverage is augmented to also include a small circle centered at a cell's access point location (see FIG. 14). This region is used as the start to design a polygon approximation to it, as shown FIG. 11A-11C. Hence, the coverage of the cell is represented as the union of these two regions (see FIG. 10). Then, each region is taken and represented as a complex polygon (FIGS. 11A-11C and FIGS. 12A and 12B or 13A and 13B). This is performed for all cells. Thereafter, a sequence of LPs is run to determine coverage overlap.

In some embodiments, the algorithm runs the following loop:
While

$${P}_{min}^{RX} \geq {P}_{inf}^{RX}$$

and found_ovelaping_combo==False:
   Test Serving ECI against its likely neighbors (all same PCI) at

$${P}_{min}^{RX}$$

If coverage overlap detected by algorithm:
   found_ovelaping_combo←True

$$Set {P}_{min}^{RX} ← {P}_{min}^{RX} - {P}_{step}^{RX}$$

In some embodiments,

$${P}_{min}^{RX}$$

is varied. For example, the algorithm doesn't set

$${P}_{min}^{RX} = - 140 dBm$$

from the outset, which would be very conservative (causing the lists of likely neighbor ECIs to be unnecessarily large). In some embodiments, the algorithm begins with

$${P}_{min}^{RX} = - 120 dBm .$$

It is possible the footprint of a cell exceeds that of a geometric sector with

$${P}_{min}^{RX} set at - 120 dBm .$$

While occasionally a neighbor could be missed when a geometric overlap is used with these sectors, this type of missed overlap is at the cell edge, and in this case, there would be handovers between the two cells. Thus, in some embodiments, it is expected that neighbors at the cell edge to be detected by MME data and neighbors “closer to the cell center” will be detected by geometric sectors. If one considers that case where

$${P}_{min}^{RX} = - 120 dBm$$

detected no neighbors, then checking for overlap with

$${P}_{min}^{RX} = - 125 dBm$$

could ensure that some likely neighbors are detected, but this situation arises in a very small fraction of (serving cell, neighbor PCI) combinations. Overall, minimal impact on potential for power savings.

It is possible that no neighbors are detected (e.g., no likely ECIs found by the sector coverage algorithm). This results when there are no options with coverage overlap. In some embodiments, in this case, option 1 is to:
For each ECI with PCI value=neighbor PCI:
   Set sector beamwidth (or serving cell and given ECI) to 360°
   If overlap detected given ECI is a likely ECI
If no likely ECIs are found, increase

$${P}_{min}^{RX}$$

sensitivity and repeat the above loop
Continue until maximum preset

$${P}_{min}^{RX}$$

sensitivity is reached.
After applying option 1, if still no likely ECIs were found even after applying option for issue #1, then other options can be employed. For example, another option (e.g., option #2.1) is to use, as likely ECIs, all ECIs with the given neighbor PCI. An alternative option (e.g., option #2.2) is to delete the PCI value as a neighbor from the MR. In yet another option (e.g., option #2.3), option #2.2 is applied first. Subsequently, for each case an inaccurate MR reporting is suspected, the relevant UE rows are deleted. In this case, N equals the number of UE reports when listing a neighbor PCI that is not resolvable, and when N is below as certain value (TBD), the entire UE report can be deleted.

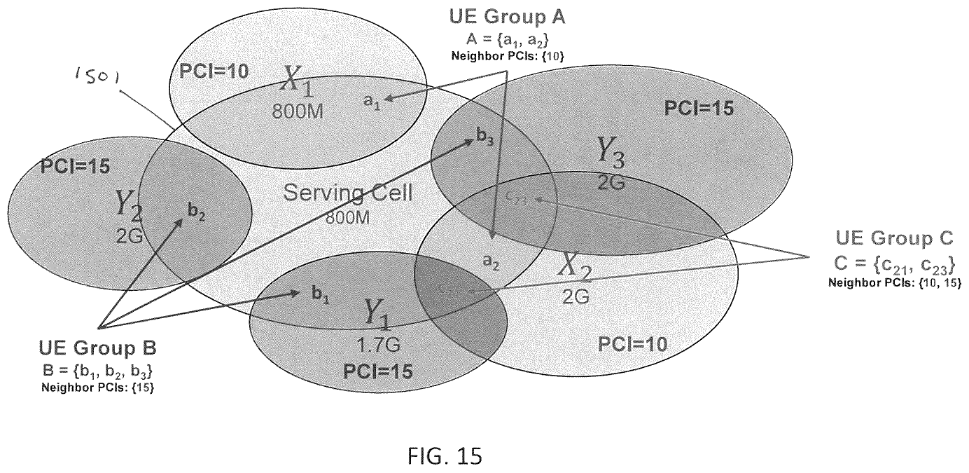

FIGS. 15-22 illustrate multiple example embodiments of PCI to ECI disambiguation as disclosed herein. FIG. 15 illustrates a network an example network in which a service cell is overlapped in coverage by two cells X₁ and X₂ that have PCI=10. The UE Group A includes {a₁, a₂} which are UEs that are being served by the serving cell and that are in radio coverage regions in which the serving cell and cells X₁ and X₂ overlap. The example network also includes the service cell being overlapped in coverage by three cells Y₁, Y₂ and Y₃ that have PCI=15. The UE Group B includes {b₁, b₂, b₃} which are UEs that are being served by the serving cell and that are in radio coverage regions in which the serving cell and cells Y₁, Y₂ and Y₃ overlap. The UE Group C have neighbor PCIs of 10 and 15 and includes {c₂₁, c₂₃} which are UEs that are being served by the serving cell and that are in regions in which there is coverage overlap between the serving cell and cells Y₁ and X₂, and overlap between the serving cell 1501 and cells Y₃ and X₂, respectively.

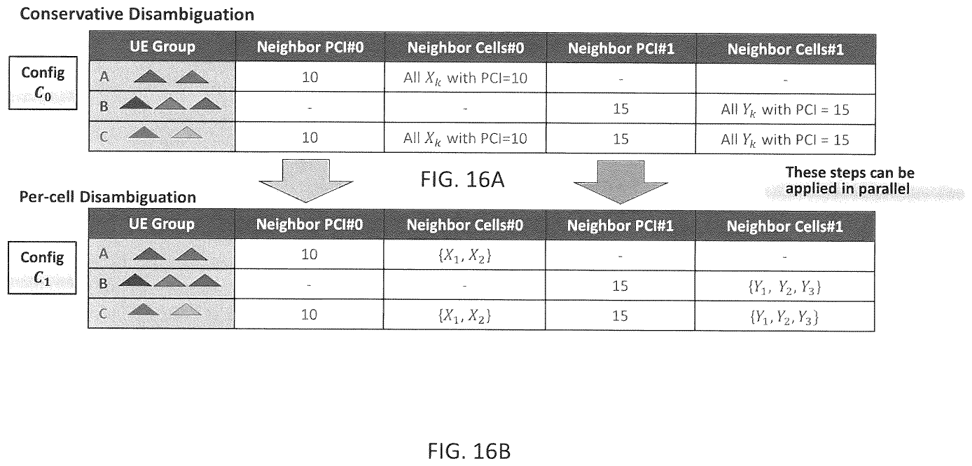

FIGS. 16A-B illustrate a first example of a per-cell embodiment. FIGS. 16A and 16B include a conservative disambiguation (configuration C₀) and a per-cell disambiguation (configuration C₁). The conservative disambiguation (configuration C₀) specifies the neighbor cells for UE group A as all cells Xₖ with a PCI=10, for UE group B as all cells Yₖ with a PCI=15, and for group C as all cells Xₖ with a PCI=10 and all cells Yₖ with a PCI=15 as shown in FIG. 16A. After applying the per-cell disambiguation, the neighbor cells for UE group A are specified as cells {X₁, X₂}, for UE group B as cells {Y₁, Y₂, Y₃}, and for group C as cells {X₁, X₂} and cells {Y₁, Y₂, Y₃} as shown in FIG. 16B.

FIGS. 17A-C illustrate a second example of a per-cell embodiment in which neighbor cells are identified based on a band restriction. FIGS. 17A-17C include a first conservative disambiguation (configuration C₀), a second conservative disambiguation on band F (configuration C₂) in which neighbor cells are identified based on a band F restriction, and a per-cell disambiguation (configuration C₃). The first conservative disambiguation (configuration C₀) is the same a FIG. 16A and specifies the neighbor cells as all cells Xₖ with a PCI=10 for both UE groups A and C and all cells Yₖ with a PCI=15 for both UE groups B and C as shown in FIG. 16A. The second conservative disambiguation on band F (configuration C₂) specifies the neighbor cells for UE group A as all cells Xₖ with a PCI=10 and band F, for UE group B as cells Yₖ with a PCI=15 and band F, and for UE group C as all cells Xₖ with a PCI=10 and band F and all cells Yₖ with a PCI=15 and band F as shown in FIG. 17B. After applying the per-cell disambiguation, the neighbor cells specified for UE group A is cell {X₂}, the neighbor cells specified for UE group B are cells {Y₂, Y₃}, and the neighbor cells specified for UE group C are cell {X₂} and cells {Y₂, Y₃} as shown in FIG. 17C.

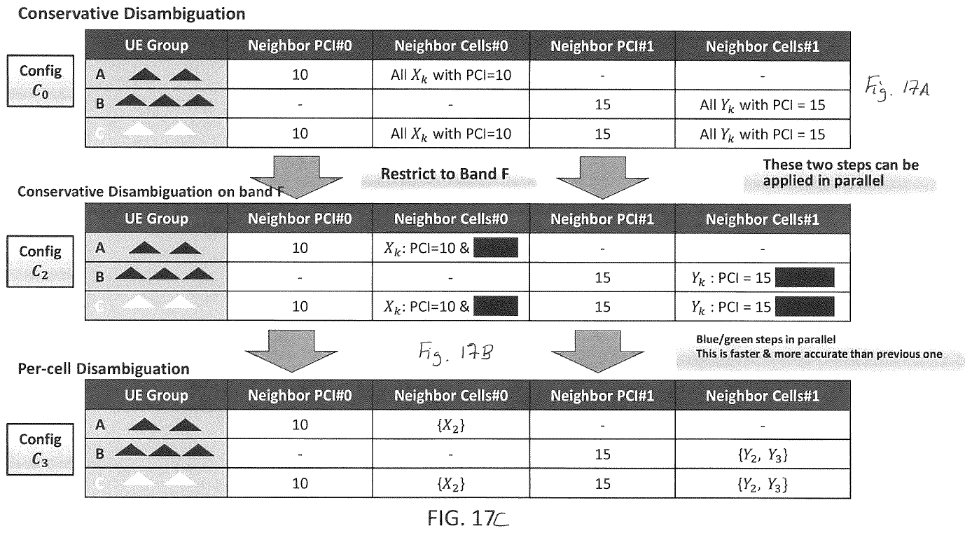

FIGS. 18A-B illustrate a first example of a per-UE embodiment. FIGS. 18A and 18B include a conservative disambiguation (configuration C₀) and a per-UE disambiguation (configuration C₄). The conservative disambiguation (configuration C₀) specifies the neighbor cells for UE group A as all cells Xₖ with a PCI=10, for UE group B as all cells Yₖ with a PCI=15, and for group C as all cells Xₖ with a PCI=10 and all cells Yₖ with a PCI=15 as shown in FIG. 18A. After applying the per-UE disambiguation, the neighbor cells are specified for UE group A as cells {X₁, X₂}, for group B as cells {Y₁, Y₂, Y₃}, and for group C as cells {X₂} and {Y₁, Y₃} as shown in FIG. 18B.

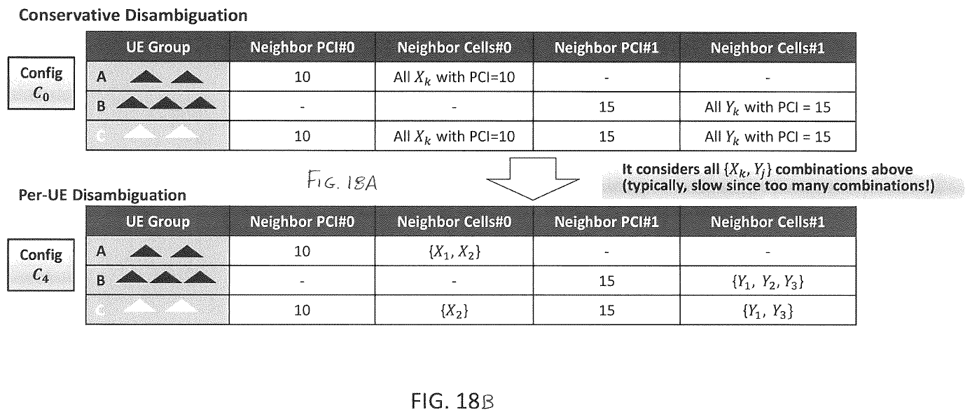

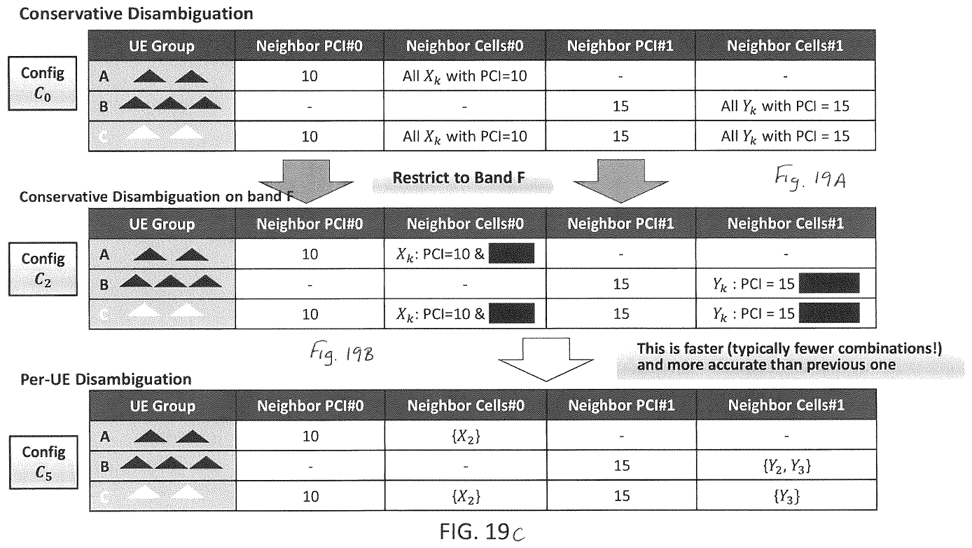

FIGS. 19A-C illustrate a second example of a per-UE embodiment in which neighbor cells are identified based on a band restriction. FIGS. 19A-19C include a first conservative disambiguation (configuration C₀), a second conservative disambiguation on band F (configuration C₂) in which neighbor cells are identified based on a band F restriction, and a per-UE disambiguation (configuration C₃). The first conservative disambiguation (configuration C₀) is the same a FIG. 16A and specifies the neighbor cells for UE group A as all cells Xₖ with a PCI=10, for UE group B as all cells Yₖ with a PCI=15, and for group C as all cells Xₖ with a PCI=10 and all cells Yₖ with a PCI=15 as shown in FIG. 19A. The second conservative disambiguation on band F (configuration C₂) specifies the neighbor cells for UE group A as all cells Xₖ with a PCI=10 and band F, for UE group B as cells Yₖ with a PCI=15 and band F, and for UE group C as all cells Xₖ with a PCI=10 and band F and all cells Yₖ with a PCI=15 and band F as shown in FIG. 19B. After applying the per-UE disambiguation, the neighbor cell specified for UE group A is cell {X₂}, the neighbor cells specified for UE group B are cells {Y₂, Y₃}, and the neighbor cells specified for UE group C are cell {X₂} and cells {Y₂, Y₃} as shown in FIG. 19C.

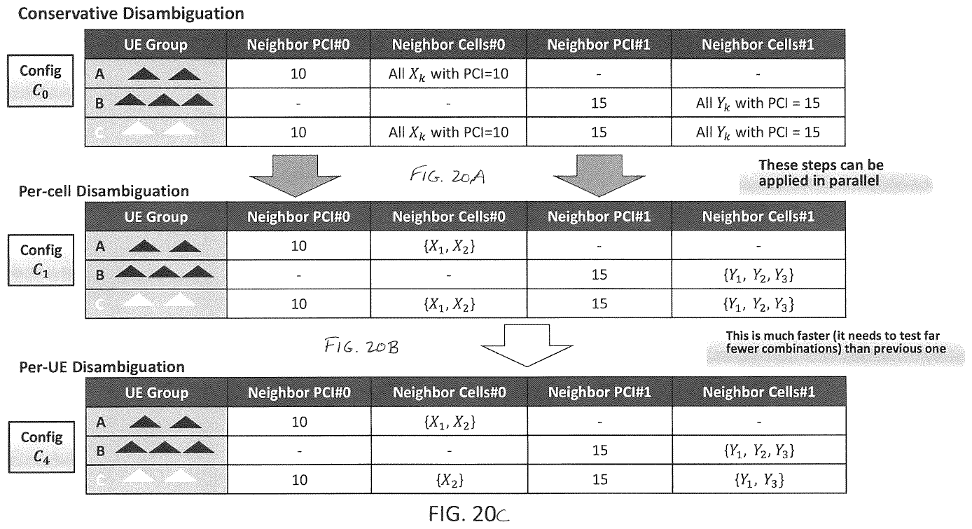

FIGS. 20A-C illustrate a second example of a per-UE embodiment in which neighbor cells are identified. FIGS. 20A-20C include a conservative disambiguation (configuration C₀), a per-cell disambiguation (configuration C₂) in which neighbor cells are identified, and a per-UE disambiguation (configuration C₄). The conservative disambiguation (configuration C₀) is the same a FIG. 16A and specifies the neighbor cells for UE group A as all cells Xₖ with a PCI=10, for UE group B as all cells {Y₁, Y₂, Y₃}, and for group C as all cells Xₖ with a PCI=10 and all cells Yₖ with a PCI=15 as shown in FIG. 20A. The per-cell disambiguation (configuration C₁) specifies the neighbor cells for UE group A as cells {X₁, X₂}, for UE group B as cells {Y₁, Y₂, Y₃}, and for UE group C as cells {X₁, X₂} and cells {Y₁, Y₂, Y₃} as shown in FIG. 20B. After applying the per-UE disambiguation, the neighbor cells specified for UE group A is cells {X₁, X₂}, the neighbor cells specified for UE group B are cells {Y₁, Y₂, Y₃}, and the neighbor cells specified for UE group C are cell {X₂} and cells {Y₁, Y₃} as shown in FIG. 20C. Comparison of FIGS. 18A-18C and 20A-20C reveals that both approaches return as their output the same per-UE configuration C₄. However, the approach in FIG. 20A-20C has much lower runtime requirements. This is because obtaining configuration C₄ from configuration C₁ requires testing far fewer cell combinations (for geometric sector overlap) than obtaining configuration C₄ from configuration C₀.

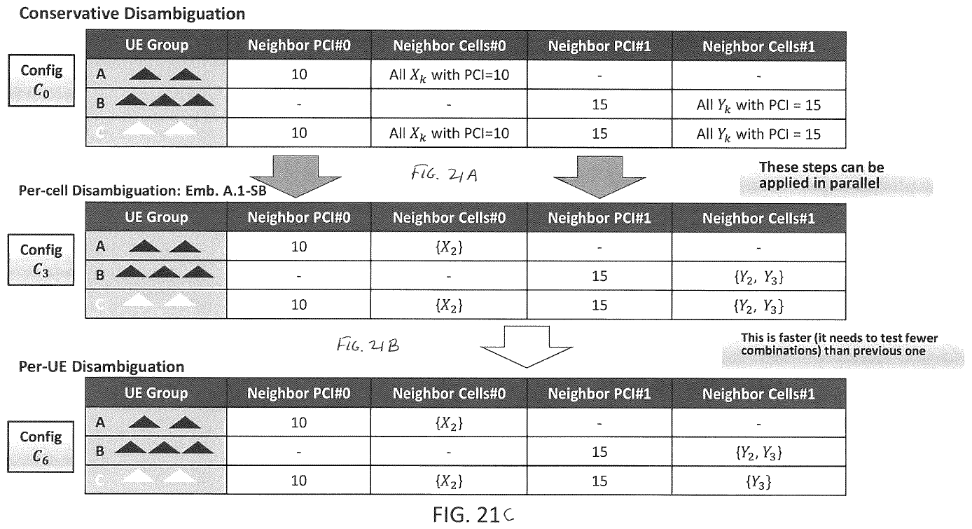

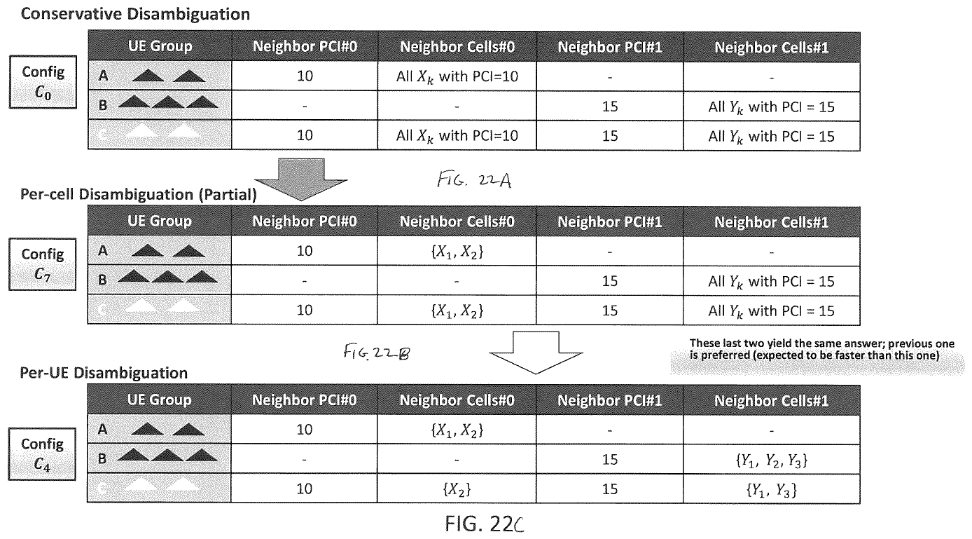

FIGS. 21A-C illustrate a third example of a per-UE embodiment in which neighbor cells are identified based on a band restriction. FIGS. 21A-21C include a conservative disambiguation (configuration C₀), a per-cell disambiguation (configuration C₂) in which neighbor cells are identified based on a band F restriction, and a per-UE disambiguation (configuration C₆). The conservative disambiguation (configuration C₀) is the same a FIG. 16A and specifies the neighbor cells for UE group A as all cells Xₖ with a PCI=10, for UE group B as cells {Y₁, Y₂, Y₃}, and for group C as all cells Xₖ with a PCI=10 and all cells Yₖ with a PCI=15 as shown in FIG. 21A. The per-cell disambiguation (configuration C₃) specifies the neighbor cells for UE group A as cells {X₁, X₂}, for UE group B as cells {Y₂, Y₃}, and for UE group C as cells {X₂} and cells {Y₂, Y₃} as shown in FIG. 21B. After applying the per-UE disambiguation, the neighbor cells specified for UE group A is cells {X₂}, the neighbor cells specified for UE group B are cells {Y₂, Y₃}, and the neighbor cells specified for UE group C are cell {X₂} and cells {Y₃} as shown in FIG. 21C. Careful inspection of FIGS. 20A-20C and 21A-21C reveals that FIG. 21A-21C provides the same type of runtime benefits as FIG. 20 in the case that band information is also available for PCI to ECI disambiguation.

FIGS. 22A-C illustrate a second example of a per-UE embodiment in which neighbor cells are identified based on a band restriction. FIGS. 22A-22C include a conservative disambiguation (configuration C₀), a per-cell disambiguation (partial) (configuration C₇) in which neighbor cells are identified based on a band F restriction, and a per-UE disambiguation (configuration C₄). The conservative disambiguation (configuration C₀) is the same as FIG. 16A and specifies the neighbor cells for UE group A as all cells Xₖ with a PCI=10, for UE group B as all cells Yₖ with a PCI=15, and for group C as all cells Xₖ with a PCI=10 and all cells Yₖ with a PCI=15 as shown in FIG. 22A. The per-cell disambiguation (configuration C₇) specifies the neighbor cells for UE group A as cells {X₁, X₂}, for UE group B as all cells Yₖ with a PCI=15, and for UE group C as cells {X₁, X₂} and all cells Yₖ with a PCI=15 as shown in FIG. 22B. After applying the per-UE disambiguation, the neighbor cells specified for UE group A is cell {X₁, X₂}, the neighbor cells specified for UE group B are cells {Y₁, Y₂, Y₃}, and the neighbor cells specified for UE group C are cell {X₂} and cells {Y₁, Y₃} as shown in FIG. 22C.

### Exemplary Flow Diagrams

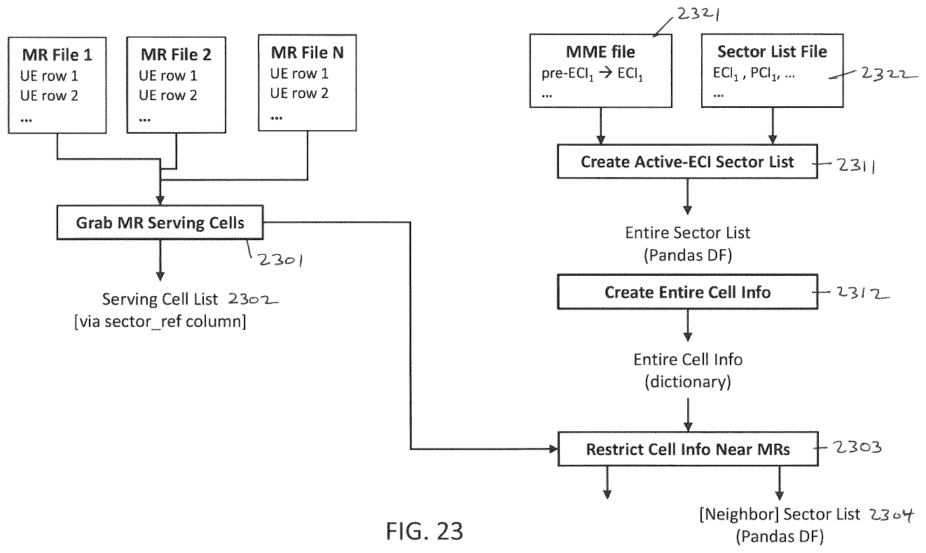

FIG. 23 is a data flow diagram of some embodiments of a data preprocessing operation. In some embodiments, the data preprocessing of FIG. 23 is performed prior to creating a tripartite graph and determining which neighbor cells should be used for offloading UEs in order to power down existing serving cells. The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 23, MR Files 1-N are used to obtain MR serving cells (processing block 2301). That is, the MR serving cells are identified using the MR Files 1-N. In some embodiments, a serving cell list is created (processing block 2302). In some embodiments, a serving cell list is used for identifying neighbor rectangles and identifying and dealing with duplicate ECIs (processing block 2303). This rectangle restriction can be used for runtime efficiency. Typically the algorithms described herein are performed over an area spanning a few thousand serving cells at a time. In downtown Tokyo, for example, the access-point location of these cells may span a rectangular area (specified by min/max longitude and min/max latitude) of 10 km×10 km. If any cell in the Tokyo area is tested as a potential neighbor candidate, then approximately several hundred thousands of cells would have to be tested. However, neighbor cells are known to be local. Therefore, the search for neighbors is initially restricted to a neighbor rectangular region centered around the 10 km×10 km rectangle but a somewhat larger. In some embodiments, the neighbor rectangular region is set between 20 km and 25 km on each side, although other sized regions can be used. This restricts the potential neighbor candidates to several tens of thousands of cells, saving a lot of unnecessarily wasted processing time and resources searching for neighbors in candidate cells that are definitely not neighbors.

As part of data pre-processing, processing logic creates an active-ECI sector list (processing block 2311). In some embodiments, processing logic creates the active-ECI sector list based on pre-ECI to ECI information in an MME file and ECI (processing block 2321), PCI correspondence information in a sector list file (processing block 2322). With respect to active ECIs, in some embodiments, the hardware corresponding to one access point corresponds to a single ECI, except in a few cases where: a) the hardware has been scheduled to be replaced; b) some new cell configurations are to be tested; c) scheduled maintenance is to be performed. In these special cases, the same cell can be described with two different ECIs, each representing a different set of hardware components, and whereby only one hardware set is active in the network at any given time. In some embodiments, these two ECIs can be assigned by the network operator two different PCI values. The two ECIs corresponding to the same cell can be identified by checking their sector reference number, which is truly unique per cell (and thus it would be the same for both ECIs). The data that is available (e.g., serving ECIs in the MR, MME data, which list ECI destination-handover pairs) can be used to identify which ECI is active at any given time, and use the active ECI's PCI value in the PCI to ECI (or, more accurately, to a set of likely neigbor cells) disambiguation process. With the entire sector list, processing logic creates entire cell information (e.g., cell information for cells in the entire Tokyo are in the example above) (processing block 2312). Processing logic can restrict cell information near MRs, based on the serving cell list (processing block 2301), to create neighbor cell and neighbor sector list information. In some embodiments, the output of restricting cell information to near MRs is a neighbor cell information dictionary and a neighbor sector list (processing block 2304).

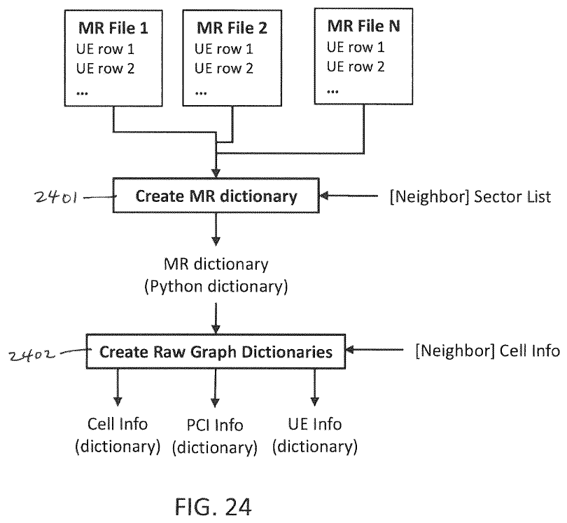

FIG. 24 illustrates some embodiments of generating raw graph dictionaries for use in creating tripartite graphs and using that information to support powering down serving cells and offloading UEs of those power down serving cells. The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 24, MR Files 1-N are used to create an MR dictionary (processing block 2401). In some embodiments, for purposes herein, a dictionary is a Python dictionary or a similar such “information carrying object”, X. The Python dictionary has the form: X[key]=value, for a bunch of keys that are specified. In some embodiments, each key could be a number, a list of numbers, a word like ‘EC’, a list of words, etc. In the case of MR, the keys of the MR dictionary include the serving-cell ECIs, and the corresponding “value” in each case would be the “combined” MR for the given serving cell. The combined MR for a given cell for example would take all the MR files and distill them into a single “elemental” MR for that serving cell. Therefore, with this in mind, in some embodiments, the flow diagrams described herein correspond to a flow diagram implementation in the Python programming language.

In some embodiments, the MR dictionary is created in response to the MR Files 1-N and a neighbor sector list, such as, for example, the neighbor sector list generated in FIG. 23. The MR dictionary comprises a single curated description of all MRs.

Using the MR dictionary, processing logic creates raw graph dictionaries (processing block 2402). In some embodiments, processing logic creates the raw graph dictionaries in response to the MR directory and neighbor cell information, such as the neighbor cell information generated in FIG. 23. In some embodiments, the output of creating raw graph dictionaries is a dictionary of cell information, a dictionary of PCI information, and a dictionary of UE information. These dictionaries contain graph-node dependencies of a tripartite graph. In some embodiments, the tripartite graph is a conservative tripartite graph.

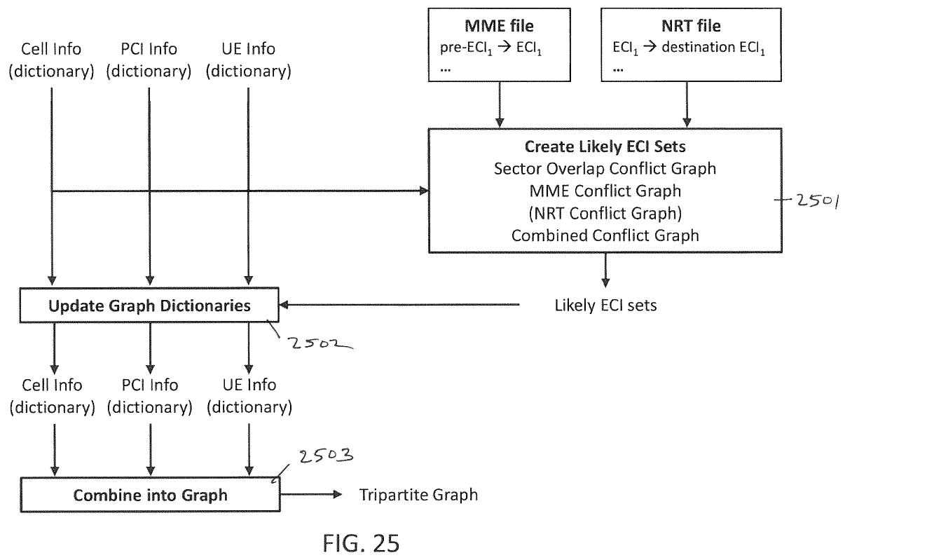

FIG. 25 is a data flow diagram of some embodiments of a process for creating a tripartite graph. The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 25, processing logic uses dictionaries of cell information, PCI information and UE information as input together with a MME file (with pre-ECI to ECI translation information) and an NRT file (with ECI to destination ECI translation information) to create likely ECI sets (processing block 2501). In some embodiments, creating the likely ECI sets includes generating one or more of a sector overlap conflict graph, an MME conflict graph, NRT conflict graph, and a combined conflict graph. A conflict graph has two sets of nodes: left nodes and right nodes. Conflicts are represented by edges connecting a left node to a right node. For purposed herein, in per-cell disambiguation, nodes to the left are serving cells and nodes to the right nodes are all potential neighbor cell candidates. In the case of a sector overlap conflict graph, a conflict represents sector overlap between a left node (serving cell) and a right node (neighbor candidate). A conflict thus signifies likely neighbors. For example, if there is a node S (the serving cell) and PCI value P has been reported by UEs in that cell, and assume nodes with ECIs X₁, X₂, . . . , X_{N} are all the possible neighbor candidates with PCI value=p. If the sector overlap method is run and an overlap is only identified between (S, X₂) and (S,X₄), then there would be edges in the graph between S, and {X₂, X₄}, but not the rest of X,'s. Similarly, with the MME conflict graph, if there are handovers only between S and X₂ and S and X₃ in the MME graph, then there would be edges between S and {X₂, X₃}, but not the rest of Xn's. The combined graph “collects” all the edges. In the example, it would have edges between S and {X₂, X₃, X₄}, but not the rest of Xₙ's. Therefore, the set of likely neighbors corresponding to PCI value=P would be {X₂, X₃, X₄}. In some embodiments, the output of creating the likely ECI sets is a set of ECI sets that includes the sets of neighbor ECI associated with each UE group in the MR.

Processing logic uses the likely ECI sets to update the graph dictionaries of the cell info (processing block 2502), PCI info and UE info, which it then combines into a tripartite graph (processing block 2503).

FIG. 26 illustrates some embodiments of a set of algorithm objects utilized to create the tripartite graph. The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 26, processing logic initializes the tripartite graph to a predetermined algorithm state(processing block 2601). In some embodiment, the predetermined algorithm state is that all the ECIs are set to the off position. As part of algorithm, processing logic updates the algorithm state based on the list of cells that are turned on and the list of bands that are on (e.g., 800 MHz) (processing block 2602). Furthermore, processing logic also takes the list of cells that must stay off and excludes certain nodes such as, for example, neighbor PCI, neighbor ECI groups (processing block 2603). This results in producing a PCI nodes exclusion list. In some embodiments, this list specifies the middle nodes (e.g., cell group nodes) of the tripartite graph that cannot be turned on by the algorithm. Turning such a middle node on implies that a cell from list of cells that are off must be turned on. In some embodiments, these middle nodes and their edge (to left and right nodes) are removed from the graph. In one embodiment, the left nodes corresponding to the cells that must stay off are also removed from the tripartite graph.

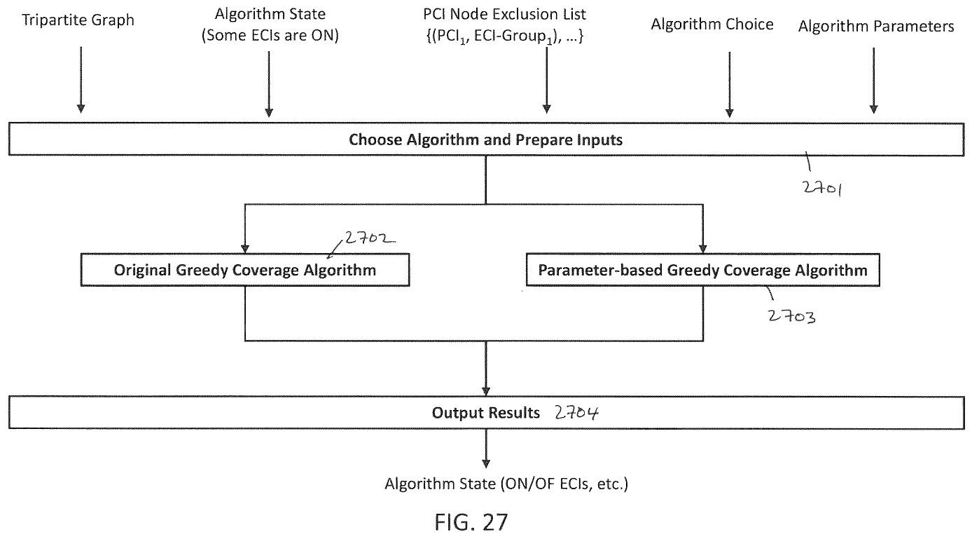

FIG. 27 is a data flow diagram of some embodiments of a process for determining which cells to turn off while offloading any of the UEs being served by those cells. The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 27, in some embodiments, the process includes processing logic choosing the algorithm to run and preparing its inputs (processing block 2701). In some embodiments, choosing the algorithm (e.g., coverage algorithm) and preparing inputs is based on tripartite graph, algorithm state (e.g., some ECIs are on), a PCI node exclusion list, the choice of the algorithm that is to be used and its parameters. Using these inputs, processing logic chooses and then runs the algorithm (processing block 2702). In some embodiments, the algorithm may be a baseline greedy coverage algorithm such as, for example, the greedy algorithm described above. In some other embodiments, the algorithm may be a parameter-based greedy coverage algorithm (processing block 2703). Note that the techniques described herein are not limited to a greedy coverage algorithm and other non-greedy coverage algorithms may be used. The results of applying the coverage algorithm to the tripartite graph are output as a result (processing block 2704). In some embodiments, the output includes the algorithm state indicative of which ECIs are to be on or off. This information can be used to offload UEs from their current serving cells to other nearby neighbor cells, thereby enable their current service cell to be put into a reduced power consumption state (e.g., a sleep state).

In some embodiments, a Greedy coverage algorithm that can be used such as mentioned above is given below. Such an algorithm can be performed as part of the flowchart in FIG. 27 with reference to tripartite graph 2 in FIG. 4A.

### Initialization:

| | | |
|---|---|---|
| E | ← set of ON ECIs | (e.g., 45K nodes) |
| P | ← Set of ON (PCI, {ECI}) pairs | (e.g., 60K nodes) |
| U | ← Set of uncovered UE groups | (e.g., 800K nodes) |

| | |
|---|---|
| No_steps | ← 0 |

While there are uncovered UE groups (i.e., U is not empty), do:

$$No\_steps ← No\_steps + 1$$

Initialization:

| | | |
|---|---|---|
| best_criterion_gain | ← 0 | (no gain) |
| best_ECI_group | ← Ø | (empty set) |

For each PCI p:
   Initialization:

| | |
|---|---|
| A ← Ø | (A will be a set of ECI subsets) |

For each set Q of likely ECIs:
   Obtain ECI subset S s Q that needs to be turned ON so that {p, Q} is turned ON
      Remark: S may be “smaller” than Q: it is possible that some ECIs in Q are already ON
   If S is not in A, add S in A
For each subset candidate S from A
   Determine new “PCI, {ECI}” pairs of the form {p, Q} that would be turned ON
   Determine the subset of UE groups from U that would be covered by turning ON S
   Compute “resulting gain” by covering these UE groups (based on criterion 1 or 2)
   If “resulting gain”>best_criterion_gain
      best_criterion_gain←“resulting gain”
      best_ECI_group←S

| | |
|---|---|
| E ← E ∪ best_ECI_group | [Add chosen ECIs into the set of ON ECIs] |
| Update P | [Update the set ON of (PCI, {ECI}) pairs] |
| Update U | [Update the set of uncovered UE groups] |
| Return E, No_steps | [Return the set of ON ECIs, and total number of |

steps]

From a high-level description perspective, in some embodiments, the Greedy coverage algorithm includes both upper and lower bounds. Examples of the upper and lower bounds are as follows:
Upper bound [conservative disambiguation]:
   Let E be the number of ON ECIs at any given time |E|
         |E| represents the worst-case scenario:
      If the algorithm is run with any less conservative PCI→{likely ECIs} assignment, it is expected that a set E′ with IE′|; |E|
Lower bound:
   At any given step of the algorithm this equals No_steps (see algorithm)
      If the algorithm is run with any less conservative PCI→{likely ECIs} assignment, it is expected that a set E′ that would satisfy with high probability:

$$\vert {E}^{′} \vert \geq No\_steps$$

The reasoning is that at every step of the algorithm . . . .
   the No_steps are increased by 1,
   more UEs are covered, and
   the minimum number of cells that would be required to achieve
   that additional UE coverage is 1 (same as the increase in No_steps)
This is a “rule of thumb” lower bound
   Examples can be created with a few cells/cell groups/UEs for which the resulting E′ yields |E′|<No_steps
   However, creating such examples is really hard and this is unlikely to happen, especially with large graphs

The Greedy algorithm can be computationally intensive. However, many options for speed-up, including parallelizing code for running on graphics processing units (GPUs), using more efficient coding of the greedy algorithm, and modifying the algorithm itself. One option related to using more efficient coding of the greedy algorithm involves identifying which cell-group metrics remain unchanged from one algorithm step to the next, so they don't have to be recomputed.

In some embodiments, lower-complexity algorithms are used such as, for example, those described above. Use of a lower-complexity algorithm can involve speeding up greedy selection, possibly at some loss in power savings provided by the assignment. Use of a lower-complexity algorithm can also involve the use of multi-candidate selection coverage algorithms. For example, at every step of the greedy selection, one or more cell groups can be selected, and which cell groups are selected depends on conditions specified by appropriately tuned parameters. For example, the algorithm that is run could select N best cell-group nodes at a time. In some embodiments, the value N can be made to varied (e.g., decrease) during the subsequent algorithm iterations.

In some embodiments, an incremental algorithm is as follows: at iteration n, the algorithm computes the metric for each cell-group node candidate that is still OFF, where a cell-group node is OFF if one or more of its cell nodes are OFF. The algorithm chooses the cell-group node with the highest metric at iteration n and turns ON all the cell nodes associated with the selected cell-group node candidate.

In some embodiments, a parameterized family of multi-candidate selection coverage algorithms can be used. In some embodiments, a parameterized family of algorithms based on greedy design can include the following:
[Parameters: α, β, N](e.g., a=95%, b=10%, N=10)
At iteration n:
   The algorithm computes the metric for each cell-group candidate that is still OFF (as with incremental algorithm)
   The algorithm selects the cell-group candidate with the highest metric (as with incremental algorithm), and possibly additional cell-group candidates
      Let Xₙ denote the selected set of cell-group candidates during iteration n
      Let m_{best}(n) denote the highest metric computed during iteration n
      The selected set Xₙ satisfies the following:
         The metric of each candidate in Xₙ is at least a % of the best metric,
         Xₙ has at most N elements (i.e., at most N cell-group nodes), and
         Xₙ has at most β% of the cell-group candidates considered for selection (i.e., still in the OFF state)
   The algorithm turns ON all the cell nodes associated with the selected cell-group candidates in X_{N}

Other algorithm options exist. For example, the right bipartite part of the graph can be used (i.e., the cell groups→UE groups portion of the graph). In this case, a greedy algorithm can be efficiently coded on the bipartite graph. This option, however, can lead to significant performance losses, as the bipartite part of the graph involving cells and cell groups is completely ignored.

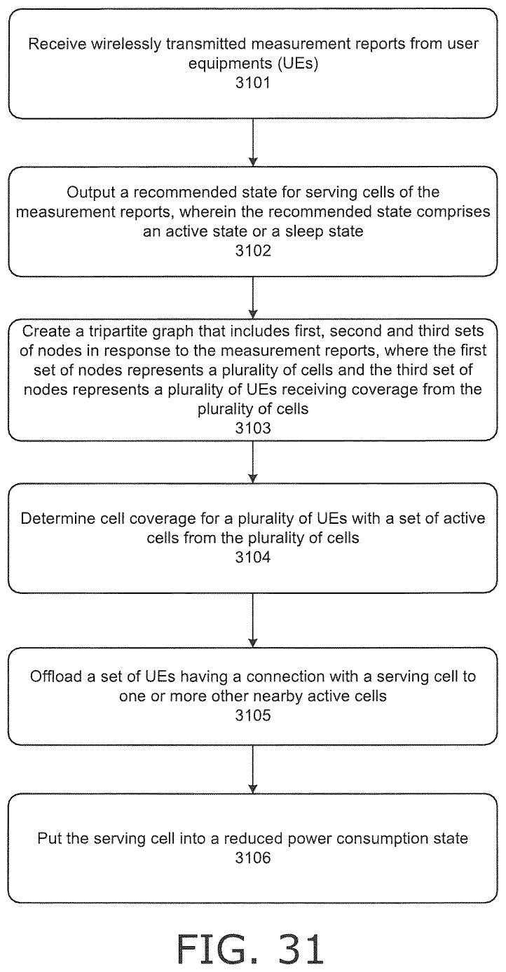

FIG. 31 is a data flow diagram of some embodiments of a process for determining cell coverage for UEs. The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 31, the process includes processing logic receiving wirelessly transmitted measurement reports from user equipments (UEs) (processing block 3101). In some embodiment, the process includes processing logic outputting a recommended state for serving cells of the measurement reports, wherein the recommended state comprises an active state or a sleep state (processing block 3102).

The process also includes processing logic creating a tripartite graph that includes first, second and third sets of nodes in response to the measurement reports, where the first set of nodes represents a plurality of cells and the third set of nodes represents a plurality of UEs receiving coverage from the plurality of cells (processing block 3103). In some embodiments, each node in the second set of nodes represents a group of one or more cells of the plurality of cells and is connected in the tripartite graph between the cells in the group and one or more UEs to which cell coverage can be obtained from at least one cell in the group provided the one or more cells in the group are indicated as on in the tripartite graph. In some embodiments, the tripartite graph is a graph that represents a combination of first and second bipartite graphs, wherein the first graph has the second set of nodes and the third set of nodes, where a first node from the third set of nodes represents a UE is on to indicate coverage is available if and only if a second node from the second set of nodes, represents a cell group, connected to the first node by an edge is on, and wherein the second graph has the second set of nodes and the first set of nodes, where a third node from the first set of nodes, represents a cell, is on if and only if a fourth node from the second set of nodes, represents a cell group, connected to the fourth node with an edge is on.

Based on the tripartite graph, processing logic determines cell coverage for a plurality of UEs with a set of active cells from the plurality of cells (processing block 3104). In some embodiments, processing logic determining, based on the tripartite graph, cell coverage to a plurality of UEs with a set of active cells from the plurality of cells by executing a coverage algorithm on the tripartite graph. In some embodiments, the coverage algorithm includes: incrementally turning candidate nodes that are in the off state to the on state one at a time; computing a metric for the candidate node when in the on state to determine impact of tuning a cell group associated with the candidate node to the on state; comparing metrics for the candidate nodes for all candidate nodes; turning one or more candidate nodes to an the on state based on a comparison of metrics; and performing another iteration of the coverage algorithm on the tripartite graph with the candidate node having a superior metric in the on state. In some embodiments, the metric comprises criterion indicative of whether additional UE nodes are covered when the cell group associated with the candidate node is on. In some other embodiments, the metric comprises criterion indicative of whether additional UE nodes are covered divided by a number of extra cells that are on, when the cell group associated with the candidate node is on.

In some embodiments, turning one or more candidate nodes to the one state based on a comparison of metrics comprises turning one candidate node, with the superior metric in comparison to metrics of other candidate nodes, to the on state. In some embodiments, turning one or more candidate nodes to the on state based on a comparison of metrics comprises turning a set of cell group candidates to the one state where the set of cell groups includes a cell group with a superior metric, in comparison to metrics of other candidate nodes, and one or more of: those cell groups having metrics within a predetermined mathematical relationship with the superior metric, a predetermined percentage of cells in the cell group, and a predetermined number of cells in the cell group.

In some embodiment, processing logic determines, based on the tripartite graph, cell coverage to a plurality of UEs with a set of active cells from the plurality of cells by executing multiple coverage algorithms on the tripartite graph which identifies candidate nodes in the second set of nodes that cover cells of the second graph and UEs on the first graph and uses a total numbers of nodes covered to compute a metric for the candidate node when in the on state to determine an impact of turning a cell group associated with the candidate node to the on state.

In some embodiments, processing logic can determine a list of cells that are options for use in providing coverage for each UE in the measurement reports and can convert each neighbor PCI reported in the measurement reports that is in the list of cells into a set of one or more neighbor cells, and wherein creating the tripartite graph is performed using the set of one or more neighbor cells.

In some embodiments, the process also includes, in response to determining the cell coverage for the UEs, offloading a set of UEs having a connection with a serving cell to one or more other nearby active cells (processing block 3105). In some embodiment, the offloading occurs in response to determining identities of the one or more nearby active cells that overlap in radio coverage with the serving cell. The offloading can be based on the list of cells that are options for use in providing coverage for each UE in the measurement reports.

After offloading the set of UEs to the one or more other nearby active cells, processing logic puts the serving cell into a reduced power consumption state (processing block 3106).

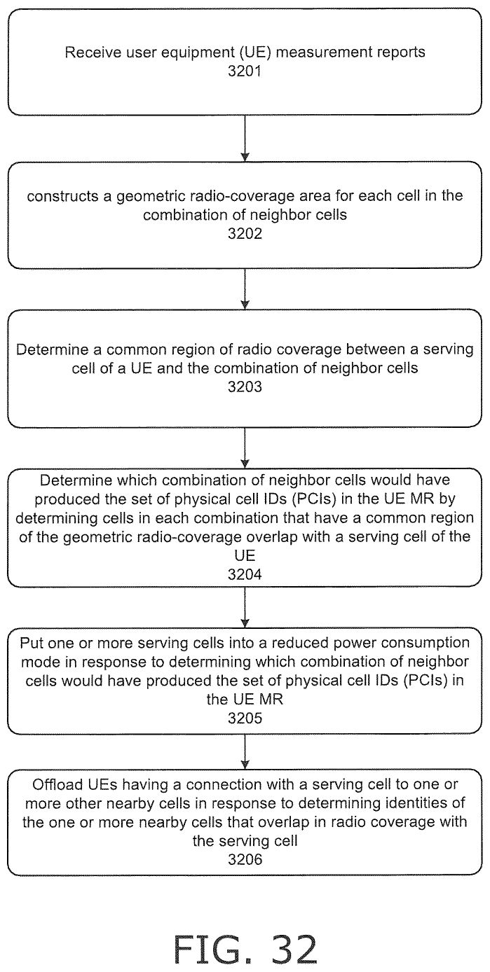

FIG. 32 is a data flow diagram of some embodiments of a process for performing neighbor-cell disambiguation. The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 32, the process includes processing logic receiving user equipment (UE) measurement reports (processing block 3201).

In some embodiments, processing logic constructs a geometric radio-coverage area for each cell in the combination of neighbor cells (processing block 3202). In some embodiments, processing logic constructs a geometric radio-coverage area for each cell in the combination of neighbor cells comprises constructing one or more convex polygons, where the union of the one or more polygons represents the geometric coverage area for each cell in the combination of neighbor cells. In some embodiments, processing logic constructs one or more convex polygons representing the geometric coverage area for each cell in the combination of neighbor cells by using sector list information and/or one or more pathloss propagation models.

In some embodiments, processing logic determines a common region of radio coverage between a serving cell of a UE and the combination of neighbor cells (processing block 3203). In some embodiments, the common region of radio coverage is a radio coverage area in which the UE was located when it collected one of the UE measurement reports. In some embodiments, processing logic makes this determination based on when the service cell overlaps in coverage with one or more cells in the combination of neighbor cells.

In some embodiments, the process also includes, in response to determining which combination of neighbor cells would have produced the set of physical cell IDs (PCIs) in the UE MR, processing logic represents the geometric coverage area of a cell as a union of coverage areas represented by a complex polygon and determines that a common coverage area between a set of cells that would have produced the set of physical cell IDs (PCIs) exists if there is an intersection of the coverage areas represented by a complex polygon, one per cell, whereby the intersection is also a convex polygon that is represented by linear constraints. Such a determination can include determining whether the intersection is empty or not based on feasibility of a linear program by applying examining all possible combinations of coverage areas, each such combination being represented by a complex polygon, and determining that such an intersection exists, if the intersection of at least one such combination is non-empty.

After determines a common region of radio coverage between a serving cell of a UE and the combination of neighbor cells, processing logic determines which combination of neighbor cells would have produced the set of physical cell IDs (PCIs) in the UE MR by determining cells in each combination that have a common region of the geometric radio-coverage overlap with a serving cell of the UE (processing block 3204). In some embodiments, the process includes processing logic disambiguating a set of PCIs associated with the UE measurement reports.

In some embodiments, the process further includes putting one or more serving cells into a reduced power consumption mode in response to determining which combination of neighbor cells would have produced the set of physical cell IDs (PCIs) in the UE MR (processing block 3205) and offloads UEs having a connection with a serving cell to one or more other nearby cells in response to determining identities of the one or more nearby cells that overlap in radio coverage with the serving cell (processing block 3206).

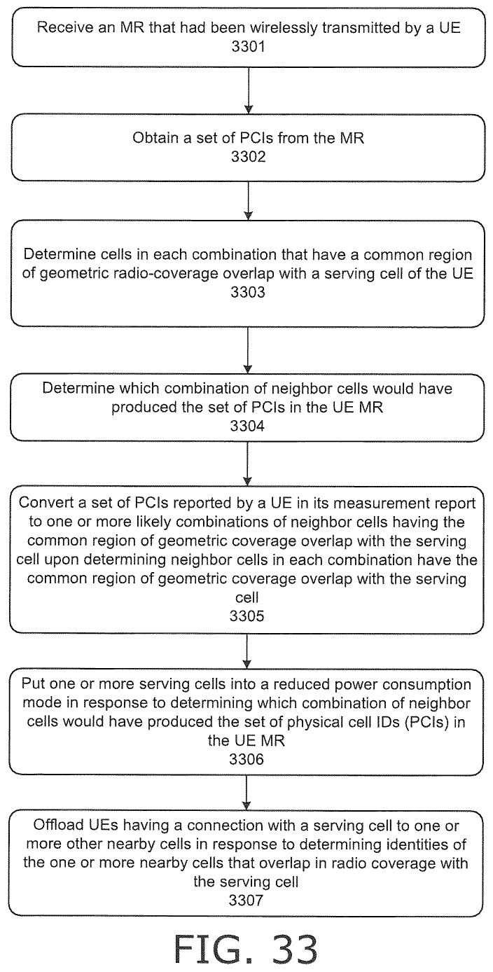

FIG. 33 a data flow diagram of some embodiments of a process for determining cell coverage for UEs. The process may be performed by processing logic that can include hardware (e.g., circuitry, dedicated logic, memory, etc.), software (such as is run on a general-purpose computer system or a dedicated machine), firmware (e.g., software programmed into a read-only memory), or combinations thereof. In some embodiments, the process is performed by a network controller in the mobile network communication system.

Referring to FIG. 33, the process includes processing logic receiving an MR that had been wirelessly transmitted by a UE (processing block 3301) and obtaining a set of PCIs from the MR (processing block 3302).

The process also includes processing logic determining cells in each combination that have a common region of geometric radio-coverage overlap with a serving cell of the UE (processing block 3303). As part of the processing of the geometric radio-coverage overlap, the process can include generating data representing serving cell and each neighboring cell pairs and generating a set of identifiers for neighbor cells that likely overlap in radio-coverage based on the data representing the serving cell and each neighboring cell pairs. In some embodiments, processing logic determines cells in each combination that have a common region of geometric radio-coverage overlap with a serving cell of the UE by determining a sector overlap based on geometric regions. In some embodiments, the coverage overlap is between two or more geometric sectors leveraging geometric coverage region constructs.

In some other embodiments, the coverage overlap is a coverage overlap of at least two cells, and is determined by testing all tuples of convex coverage regions of the at least two cells; determining whether a coverage overlap exists with at least one tuple of convex coverage regions of the at least two cells; and providing an indication that an overlap in coverage has been detected upon determining the coverage overlap with the at least one tuple of convex coverage regions of the at least two cells. In some embodiments, when determining the coverage overlap, processing logic determines a union of convex regions, with each convex region described by a set of linear constraints. In some embodiments, the convex regions are polygons. In some embodiments, the linear constraints represent a region within a shape of the sector. In some embodiments, processing logic determines the union of convex regions by mapping each convex polygon to a set of linear constraints and determining whether several convex polygons from all the polygons are simultaneously feasible using a linear program with an objective function and linear constraints describing polygons.

Based on which cells in each combination that have a common region of geometric radio-coverage overlap with a serving cell of the UE, processing logic determines which combination of neighbor cells would have produced the set of PCIs in the UE MR (processing block 3304).

In some embodiment, the process further comprises converting a set of PCIs reported by a UE in its measurement report to one or more likely combinations of neighbor cells having the common region of geometric coverage overlap with the serving cell upon determining neighbor cells in each combination have the common region of geometric coverage overlap with the serving cell (processing block 3305).

In some embodiments, the process further includes putting one or more serving cells into a reduced power consumption mode in response to determining which combination of neighbor cells would have produced the set of physical cell IDs (PCIs) in the UE MR (processing block 3306) and offloads UEs having a connection with a serving cell to one or more other nearby cells in response to determining identities of the one or more nearby cells that overlap in radio coverage with the serving cell (processing block 3307).

### An Example of a Base Station

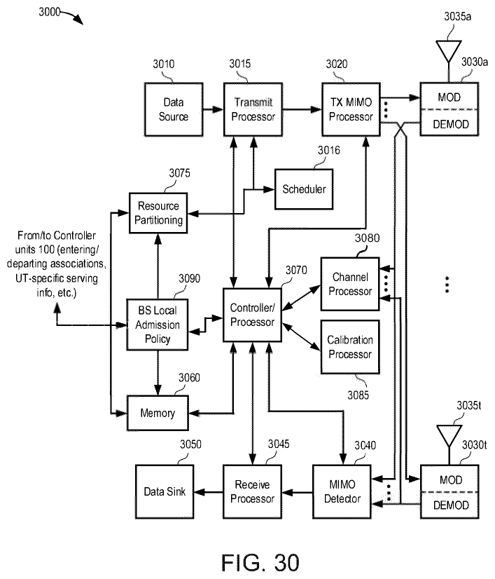

FIG. 30 is a block diagram of some embodiments of a base station. Referring to FIG. 30, in one embodiment, base station 3000 serves one or more cells and is equipped with Nₜ antennas, 3035ₐ through 3035ₜ. Base station 3000 includes a transmit processor 3015 that receives data for one or more UE from a data source 3010, processes the data for each UE, and transmits data for each UE. In one embodiment, processor 3015 also receives and processes information from a controller processor 3070 and provides control symbols. In one embodiment, processor 3015 also generates reference symbols for one or more reference signals. A transmit (TX) MIMO processor 3020 performs precoding on the data symbols, the control symbols, and/or the reference symbols for each UE based on one or more precoding vectors determined for that UE. In one embodiment, processor 3020 provides (up to) Nₜ output streams, one to each of the modulators (MODs) in modules 3030a through 3030t. Each modulator 3030 processes its respective stream (e.g., for OFDM, etc.) to obtain an output sample stream. Each modulator 3030 further processes (e.g., convert to analog, amplify, filter, upconvert, etc.) the output sample stream to obtain a downlink signal. Up to Nₜ output streams from modulators 3030a through 3030t are transmitted via Nₜ antennas 3035a through 3035t, respectively.

The uplink signals from UEs are received by antennas 3035, processed by demodulators 3030, detected by a MIMO detector 3040 and further processed by a receive processor 3045 to obtain decoded data and control information sent by UEs. Processor 3045 provides the decoded data to a data sink 3050 and the decoded control information to controller/processor 3070.

A channel processor 3080 at base station 3000 estimates the channel response from UE 200 and other UEs of interest and provides a channel matrix for each UE. In one embodiment, processor 3070 and/or 3080 determines channel information based on channel matrix for each UE of interest. In accordance with one embodiment, processor 3080 stores determined channel matrix in memory module 3060, for later use. Base station local admission policy 3090 for base station 3000 handles admission of UEs, while resource partitioning block 3075 handles resource partitioning for base station 3000. Calibration processor 3085 performs and controls calibration operations.

In one embodiment, scheduler 3016 schedules UEs for data transmission on the downlink and/or uplink. Scheduler 3016 and/or other processors and modules at base station 3000 may perform processes for the techniques described herein. These include scheduling transmission of control information in the uplink by UEs.

Controller/processor 3070 directs the operation at base station 3000. Memory 3060 may store data and program codes for base station 3000. These operations include those operations described above.

There are a number of example embodiments described herein.

Example 1 is a method including receiving wirelessly transmitted measurement reports from user equipments (UEs); creating, in response to the measurement reports, a tripartite graph that includes first, second and third sets of nodes, the first set of nodes representing a plurality of cells, the third set of nodes representing a plurality of UEs receiving coverage from the plurality of cells, each node in the second set of nodes representing a group of one or more cells of the plurality of cells and being connected in the tripartite graph between the one or more cells in the group and one or more UEs to which cell coverage can be obtained from at least one cell in the group provided the one or more cells in the group are indicated as on in the tripartite graph; and determining, based on the tripartite graph, cell coverage for a plurality of UEs with a set of active cells from the plurality of cells.

Example 2 is the method of example 1 that may optionally include, in response to determining, offloading a set of UEs having a connection with a serving cell to one or more other nearby active cells determined in response to determining identities of the one or more nearby active cells that overlap in radio coverage with the serving cell; and putting the serving cell into a reduced power consumption state after offloading the UEs to the one or more other nearby active cells.

Example 3 is the method of example 1 that may optionally include outputting a recommended state for serving cells of the measurement reports, wherein the recommended state comprises an active state or a sleep state.

Example 4 is the method of example 1 that may optionally include determining a list of cells that are options for use in providing coverage for each UE in the measurement reports; and converting each neighbor PCI reported in the measurement reports that is in the list of cells into a set of one or more neighbor cells, and wherein creating the tripartite graph is performed using the set of one or more neighbor cells.

Example 5 is the method of example 1 that may optionally include that determining, based on the tripartite graph, cell coverage to a plurality of UEs with a set of active cells from the plurality of cells comprises executing a coverage algorithm on the tripartite graph.

Example 6 is the method of example 5 that may optionally include that the coverage algorithm includes: incrementally turning candidate nodes that are in the off state to the on state one at a time; computing a metric for the candidate node when in the on state to determine impact of tuning a cell group associated with the candidate node to the on state; comparing metrics for the candidate nodes for all candidate nodes; turning one or more candidate nodes to an the on state based on a comparison of metrics; and performing another iteration of the coverage algorithm on the tripartite graph with the candidate node having the superior metric in the on state.

Example 7 is the method of example 6 that may optionally include that the metric comprises criterion indicative of whether additional UE nodes are covered when the cell group associated with the candidate node is on.

Example 8 is the method of example 6 that may optionally include that the metric comprises criterion indicative of whether additional UE nodes are covered divided by a number of extra cells that are on, when the cell group associated with the candidate node is on.

Example 9 is the method of example 6 that may optionally include that turning one or more candidate nodes to the one state based on a comparison of metrics comprises turning one candidate node, with the superior metric in comparison to metrics of other candidate nodes, to the on state.

Example 10 is the method of example 6 that may optionally include that turning one or more candidate nodes to the on state based on a comparison of metrics comprises turning a set of cell group candidates to the one state where the set of cell groups includes a cell group with a superior metric, in comparison to metrics of other candidate nodes, and one or more of: those cell groups having metrics within a predetermined mathematical relationship with the superior metric, a predetermined percentage of cells in the cell group, and a predetermined number of cells in the cell group.

Example 11 is the method of example 1 that may optionally include that the tripartite graph is a graph that represents a combination of first and second bipartite graphs, wherein the first graph has the second set of nodes and the third set of nodes, where a first node from the third set of nodes representing a UE is on to indicate coverage is available if and only if a second node from the second set of nodes, representing a cell group, connected to the first node by an edge is on, and wherein the second graph has the second set of nodes and the first set of nodes, where a third node from the first set of nodes, representing a cell, is on if and only if a fourth node from the second set of nodes, representing a cell group, connected to the fourth node with an edge is on.

Example 12 is the method of example 11 that may optionally include that determining, based on the tripartite graph, cell coverage to a plurality of UEs with a set of active cells from the plurality of cells comprises executing multiple coverage algorithms on the tripartite graph which identifies candidate nodes in the second set of nodes that cover cells of the second graph and UEs on the first graph and uses a total numbers of nodes covered to compute a metric for the candidate node when in the on state to determine an impact of turning a cell group associated with the candidate node to the on state.

Example 13 is a network controller including: a transceiver to collect measurement reports (MRs) of served user equipments (UEs); and one or more processors coupled to the transceiver and operable to: receive wirelessly transmitted measurement reports from UEs; create, in response to the measurement reports, a tripartite graph that includes first, second and third sets of nodes, the first set of nodes representing a plurality of cells, the third set of nodes representing a plurality of UEs receiving coverage from the plurality of cells, each node in the second set of nodes representing a group of one or more cells of the plurality of cells and being connected in the tripartite graph between the one or more cells in the group and one or more UEs to which cell coverage can be obtained from at least one cell in the group provided the one or more cells in the group are indicated as on in the tripartite graph; and determine, based on the tripartite graph, cell coverage for a plurality of UEs with a set active cells from the plurality of cells.

Example 14 is the network controller of example 13 that may optionally include that the one or more processors are further operable to, in response to determining cell coverage for a plurality of UEs, offload a set of UEs having a connection with a serving cell to one or more other nearby active cells determined in response to determining identities of the one or more nearby active cells that overlap in radio coverage with the serving cell; and put the serving cell into a reduced power consumption state after offloading the UEs to the one or more other nearby active cells.

Example 15 is the network controller of example 13 that may optionally include that the one or more processors are further operable to output a recommended state for serving cells of the measurement reports, wherein the recommended state comprises an active state or a sleep state.

Example 16 is the network controller of example 13 that may optionally include that the one or more processors are further operable to: determine a list of cells that are options for use in providing coverage for each UE in the measurement reports; and convert each neighbor PCI reported in the measurement reports that is in the list of cells into a set of one or more neighbor cells, and wherein creating the tripartite graph is performed using the set of one or more neighbor cells.

Example 17 is the network controller of example 13 that may optionally include that the one or more processors are further operable to determine, based on the tripartite graph, cell coverage to a plurality of UEs with a set active cells from the plurality of cells comprises executing a coverage algorithm on the tripartite graph.

Example 18 is the network controller of example 17 that may optionally include that the coverage algorithm comprises: incrementally turning candidate nodes that are in the off state to the on state one at a time; computing a metric for the candidate node when in the on state to determine impact of tuning a cell group associated with the candidate node to the on state; comparing metrics for the candidate nodes for all candidate nodes; turning one or more candidate nodes based on a comparison of metrics; and perform another iteration of the coverage algorithm on the tripartite graph with the candidate node having the superior metric in the on state.

Example 19 is the network controller of example 18 that may optionally include that the metric comprises one of a group consisting of: criterion indicative of whether additional UE nodes are covered when the cell group associated with the candidate node is on and criterion indicative of whether additional UE nodes are covered divided by a number of extra cells that are on, when the cell group associated with the candidate node is on.

Example 20 is the network controller of example 18 that may optionally include that turning one or more candidate nodes based on a comparison of metrics comprises turning one candidate node with a superior metric in comparison to metrics of other candidate nodes to the on state.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general-purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

In the claims, reference to an element in the singular is not intended to mean “one and only one” unless explicitly so stated, but rather “one or more.” All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

In addition to any other claims, the applicant(s)/inventor(s) claim each and every embodiment of the technology described herein, as well as any aspect, component, or element of any embodiment described herein, and any combination of aspects, components or elements of any embodiment described herein.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method for neighbor-cell disambiguation, the method comprising:
receiving user equipment (UE) measurement reports; and
determining which combination of neighbor cells would have produced the set of physical cell IDs (PCIs) in the UE MR by determining cells in each combination that have a common region of geometric radio-coverage overlap with a serving cell of the UE.

2. The method of claim 1 further comprising constructing a geometric radio-coverage area for each cell in the combination of neighbor cells.

3. The method of claim 2 wherein constructing a geometric radio-coverage area for each cell in the combination of neighbor cells comprises constructing one or more convex polygons, the union of the one or more polygons representing the geometric coverage area for each cell in the combination of neighbor cells.

4. The method of claim 3 wherein constructing one or more convex polygons representing the geometric coverage area for each cell in the combination of neighbor cells is performed using sector list information and/or one or more pathloss propagation models.

5. The method of claim 1 further comprising determining a common region of radio coverage between a serving cell of a UE and the combination of neighbor cells, the common region of radio coverage being a radio coverage area in which the UE was located when it collected one of the UE measurement reports.

6. The method of claim 5 further comprising determining when the service cell overlaps in coverage with one or more cells in the combination of neighbor cells.

7. The method of claim 1 further comprising disambiguating a set of PCIs associated with the UE measurement reports.

8. The method of claim 1 further comprising, in response to determining, putting one or more serving cells into a reduced power consumption mode.

9. The method of claim 1 further comprising, in response to determining, offloading UEs having a connection with a serving cell to one or more other nearby cells in response to determining identities of the one or more nearby cells that overlap in radio coverage with the serving cell.

10. The method of claim 1 further comprising, in response to determining,
representing a geometric coverage area of a cell as a union of coverage areas represented by a complex polygon; and
determining that a common coverage area between a set of cells that would have produced the set of physical cell IDs (PCIs) exists if there is an intersection of the coverage areas represented by a complex polygon, one per cell, whereby the intersection is also a convex polygon that is represented by linear constraints, including determining whether the intersection is empty or not based on feasibility of a linear program by applying examining all possible combinations of coverage areas, each such combination being represented by a complex polygon, and determining that such an intersection exists, if the intersection of at least one such combination is non-empty.

11. A network controller comprising:
a transceiver to collect measurement reports (MRs) of served user equipments (UEs); and
one or more processors coupled to the transceiver and operable to:
receive user equipment (UE) measurement reports; and
determine which combination of neighbor cells would have produced the set of physical cell IDs (PCIs) in the UE MR by determining cells in each combination that have a common region of geometric radio-coverage overlap with a serving cell of the UE.

12. The network controller of claim 11 wherein the one or more processors are operable to construct a geometric radio-coverage area for each cell in the combination of neighbor cells.

13. The network controller of claim 12 wherein the one or more processors construct a geometric radio-coverage area for each cell in the combination of neighbor cells by constructing one or more convex polygons collectively representing the geometric coverage area for each cell in the combination of neighbor cells.

14. The network controller of claim 13 wherein the one or more processors are operable to construct one or more convex polygons collectively representing the geometric coverage area for each cell in the combination of neighbor cells using sector list information and/or one or more pathloss propagation models.

15. The network controller of claim 11 wherein the one or more processors are operable to determine a common region of radio coverage between a serving cell of a UE and the combination of neighbor cells, the common region of radio coverage being a radio coverage area in which the UE was located when it collected one of the UE measurement reports.

16. The network controller of claim 15 wherein the one or more processors are operable to determine when the service cell overlaps in coverage with one or more cells in the combination of neighbor cells.

17. The network controller of claim 11 wherein the one or more processors are operable to disambiguate a set of PCIs associated with the UE measurement reports.

18. The network controller of claim 11 wherein the one or more processors are operable to, in response to determining, put one or more serving cells into a reduced power consumption mode.

19. The network controller of claim 11 wherein the one or more processors are operable to, in response to determining, offload UEs having a connection with a serving cell to one or more other nearby cells in response to determining identities of the one or more nearby cells that overlap in radio coverage with the serving cell.

20. The network controller of claim 11 wherein the one or more processors are operable to, in response to determining,
represent a geometric coverage area of a cell as a union of coverage areas represented by a complex polygon; and
determine that a common coverage area between a set of cells that would have produced the set of physical cell IDs (PCIs) exists if there is an intersection of the coverage areas represented by a complex polygon, one per cell, whereby the intersection is also a convex polygon that is represented by linear constraints, wherein the one or more processors determine whether the intersection is empty or not based on feasibility of a linear program by applying examining all possible combinations of coverage areas, each such combination being represented by a complex polygon, and determine that such an intersection exists, if the intersection of at least one such combination is non-empty.
